(19) United States
(12) Patent Application Publication
(10) Pub. No.: US 2018/0165705 A1
(43) Pub. Date: Jun. 14, 2018

(54) SYSTEMS AND METHODS FOR PROVIDING INSTANT REBATES TO CUSTOMERS

(71) Applicant: Blackhawk Network, Inc., Pleasanton, CA (US)

(72) Inventors: Jason Schwomeyer, Grapevine, TX (US); Franz Zemen, Grapevine, TX (US); Kahnec DeLaTorre, Frisco, TX (US); Srinivas Sirigina, Carrollton, TX (US); Dan Hawtof, Dallas, TX (US); Bipin Velkur, Coppell, TX (US); Jay Grinde, Plano, TX (US); Anchit Tapadia, Carrollton, TX (US); Meghan Mahn, Dallas, TX (US); Ankita Gupta, Lewisville, TX (US)

(21) Appl. No.: 15/893,311

(22) Filed: Feb. 9, 2018

Related U.S. Application Data
(63) Continuation-in-part of application No. 15/343,073, filed on Nov. 3, 2016.
(60) Provisional application No. 62/456,891, filed on Feb. 9, 2017.
(60) Provisional application No. 62/250,257, filed on Nov. 3, 2015.

(51) Int. Cl. G06Q 30/02

(52) U.S. Cl. CPC G06Q 30/0234; G06Q 20/342

(57) ABSTRACT

Systems and methods for associating rebate instances with rebate fulfillment comprising receiving a setup control signal; generating a one or more programs from the one or more programs; selecting one of the one or more programs as a rebate instance; and associating the rebate instance with a rebate fulfillment as an association. The method and the system may further utilize activation and login signals, as well as storing the association for further association and activation.

### CROSS-REFERENCE TO RELATED APPLICATIONS

This application claims priority to U.S. Provisional Patent Application Ser. No. 62/456,891, filed Feb. 9, 2017 and entitled “Systems and Methods for Providing Instant Rebates to Customers;” this application is also a continuation in part of, and claims priority to, U.S. patent application Ser. No. 15/343,073 filed Nov. 3, 2016 and entitled “System and Method Targeted Marketing and Consumer Resource Management,” which claims priority to U.S. Provisional Patent Application No. 62/250,257 filed Nov. 3, 2015 and entitled “Enhanced Rebate Program,” each of which is incorporated by reference herein in their entirety.

### BACKGROUND

### Field of the Disclosure

The present disclosure relates to systems and methods for using computer network technology to provide consumers with resource management capabilities and to provide retailers, service providers and manufacturers with enhanced marketing channels.

### Description of Related Art

The Internet has evolved into an entire marketplace offering consumers the ability to shop for goods and services and make transactions electronically without leaving their home. The Internet has also expanded distribution channels and ways of reaching consumers through advertising for retailers, service providers and manufacturers. The Internet and a number of more evolutionary technologies have also evolved to provide retailers, service providers and manufacturers (“retailers”) with ways to attract consumers to their traditional sources of goods. For example, many retailers sell gift cards that may be redeemed at the retailers' stores for a predetermined amount. Many retailers have also established loyalty programs, or awards programs, and some have provided consumers with access to accounts over the Internet. Retailers have also used the Internet to provide consumers with coupons, rebates, and directed notices of offers and savings. Retailers may obtain marketing information about consumers to help them determine what's selling and what's not.

Despite the revolutionary growth of the Internet as a market place, there are frustrations faced by both consumers and retailers alike. Consumer frustration primarily centers on resource management issues (managing information, gift cards, coupons, receipts, spam, loyalty program cards, rebates, etc.).

Retailer frustration centers on having poor access to consumer attention and information. Consumers faced with an overwhelming number of offers, rebates, and ads find it difficult to take advantage of such offers, rebates and ads leaving retailers clueless as to how successful their campaigns are, or what products are selling as a result of the campaigns, or who is buying what products. Furthermore, retailers often direct a campaign to a particular consumer that is wholly uninterested in the product or service, or is uninterested at that particular time. Retailers generally over communicate with consumers, hoping to catch them at a time when they will be interested, leading to consumers being inundated with irrelevant communications. These frustrations are not only related but are literally caused by the opposing party. Trying to solve the needs of one without simultaneously addressing the needs of the other is an exercise in futility.

While gift cards have become popular, they've also become a source of confusion and clutter. A consumer cannot know the balance on most gift cards without visiting the store, and often, a consumer will have many gift cards from a wide variety of retailers. Keeping track of the gift cards requires meticulous record-keeping. Many gift cards often end up being unused, providing no advantage to the consumer and little advantage to the retailer. In addition to gift cards, consumers often experience frustration with having to store receipts, or receiving unsolicited offers by email, or having to keep track of many passwords to access many accounts for loyalty programs or award programs.

While rebates have become more popular, they've also become a source of confusion and neglect. Rebates take a certain amount of time and effort from the consumer. The consumer must (1) adhere to all the rebate submission rules; (2) fill out the rebate forms; (3) prepare the mail-in submission with the necessary proofs of rebate entitlement; and (4) not forget to check on the rebate status after several weeks/months have gone by without the receipt of the rebate amount. Chances of rebate mailing being lost or failing some criteria may further reduce the expected return on this effort. Consumers who are aware of this, and who value their time, effort, and opportunity costs above the value of the rebate may choose to intentionally ignore a first retailer's product or service with a typical rebate offer that requires such procedures and pay an slightly lower out-the-door price for a second retailer's competing product or service (although the rebate-adjusted price for the first retailer's product or service would result in the consumer ultimately paying less for the first retailer's product or service that for the second retailer's competing product or service).

Conventional rebates programs are underutilized due to focus on increased end-user time and effort to obtain the rebate. It would therefore be desirable to shift much of the time and effort associated with rebate programs to other parties while maintaining the security of transactions. Thus, there is a need for systems and methods that would improve consumer satisfaction and the effectiveness of rebate campaigns by providing consumers with benefits from a rebate campaign, instantly.

### SUMMARY

In view of the above, methods and systems are provided for real-time submission of a rebate request, real-time validation, and real-time rebate reward. For example, a trade ally (e.g., authorized rebate submitter such as an installer, contractor, delivery person, customer service representative) enrolls in an instant rebate program. The trade ally completes the work/delivery/installation of the product/service associated with a rebate offering for a consumer. The trade ally submits the rebate associated with the work/delivery/installation of the product/service to the instant rebate program processor. The instant rebate program processor validates and/or verifies the eligibly of the trade ally, the consumer, and the product or service performed for the requested rebate. The instant rebate program processor associates the valid/verified request with a rebate fulfillment value. The consumer is provided with the rebate fulfillment value. In some embodiments, the consumer must activate the rebate fulfillment value prior the consumer's use of the rebate fulfillment value.

In another aspect of the disclosure, methods are provided for on the spot consumer resource management. In accordance to one example method, a consumer interface is provided on a network terminal available to a consumer (customer can be used interchangeably with consumer). The consumer provides consumer input at the network terminal and the consumer input is communicated to an enterprise infrastructure. A consumer account is configured based on the consumer input at the enterprise infrastructure. The consumer account includes a partner interface to access a plurality of selected goods and services providers. The consumer account is also configured to set fund balances for at least one selected goods and services provider. The consumer then purchases a gift card from the enterprise infrastructure to enable purchases from at least one selected goods and services provider.

In another aspect of the disclosure, another example of a method for providing consumer resource management includes generating a universal transaction identifier from the enterprise infrastructure, the universal transaction identifier corresponding to the consumer account to enable purchases from a plurality of the selected goods and services providers.

In another aspect of the disclosure, a method is provided for targeted marketing by a goods and services provider. According to the example method, transaction data is collected from point-of-sale (POS) terminals processing transactions. The transaction data includes a consumer identifier for each consumer involved in the transactions. The transaction data is sent to an enterprise infrastructure. For each transaction, a consumer account is accessed in the enterprise infrastructure for each consumer based on the consumer identifiers. The transaction data is then recorded in the corresponding consumer accounts. The goods and services provider is provided with the information relating to consumers that purchased goods and services from the goods and services provider. The goods and services provider may then use the information to target consumers to receive offers, coupons, and savings.

In another aspect of the disclosure, systems and methods are provided for utilizing a consumer's participation in an enhanced rebate and marketing program to automatically enroll the consumer in a loyalty program of sponsor of the rebate program (and/or in a loyalty program of a partner/designee of the sponsor of the rebate program). According to disclosed examples, data is collected from the consumer (via on-line submissions using, e.g., a computer, tablet, smartphone, smart TV or other device or via the consumer completing a paper mail-in process), wherein the consumer selects/designates the types and extent of personal information provided as part of the rebate validation process and said personal information is then utilized by the systems and methods to automatically enroll the consumer in a specified loyalty program. The data can include a consumer identifier for each consumer involved in the rebate program as well as bonus preferences, social media preferences, marketing preferences, purchasing preferences, etc. The consumer data is sent to an enterprise infrastructure. Goods and services providers, transaction processors, prepaid card issuers, and rebate program sponsors are provided with the consumer data. The consumer data collected as part of the consumer's participation in the rebate program may then be used to target consumers to receive offers, coupons, savings, advertisements, questionnaires and to share offers, coupons, savings, and reviews with other consumers via social media platforms, direct, or indirect communications.

Various advantages, aspects and novel features of the present disclosure, as well as details of an illustrated embodiment thereof, will be more fully understood from the following description and drawings.

Other systems, methods and features of the disclosure will be or will become apparent to one with skill in the art upon examination of the following figures and detailed description. It is intended that all such additional systems, methods, features and advantages be included within this description, be within the scope of the disclosure, and be protected by the accompanying claims.

### BRIEF DESCRIPTION OF THE DRAWINGS

The disclosure can be better understood with reference to the following figures. The components in the figures are not necessarily to scale, emphasis instead being placed upon illustrating the principles of the disclosure. In the figures, like reference numerals designate corresponding parts throughout the different views.

FIG. 1 is a schematic diagram of an example system for providing consumer resource management and targeted marketing.

FIG. 2 is a block diagram of an example system network that may be used to implement an example of the system in FIG. 1.

FIG. 3 is a schematic diagram depicting an example of a retail partner infrastructure.

FIG. 4 is a schematic diagram depicting another example of a retail partner infrastructure.

FIG. 5 is a schematic diagram depicting another example of a retail partner infrastructure.

FIG. 6 is a flow diagram depicting operation of an example of a Point-of-Sale (POS) terminal interface.

FIG. 7 is a flow diagram depicting operation of another example of a POS terminal interface.

FIG. 8 is a flow diagram depicting operation of another example of a POS terminal interface.

FIG. 9 is a block diagram of an example of an enterprise infrastructure interface with retail partners.

FIG. 10 is an example of a user interface that may be implemented for use by a consumer and which provides targeted offers to particular consumers.

FIG. 11A is an example of a flow diagram illustrating the delivery of special offers and savings to target consumer for access and use by the consumer.

FIG. 11B is an example of a flow diagram illustrating a consumer receipt and processing of special offers and saving.

FIG. 12 is an example of a user interface that may be implemented for use by a consumer for the purchase of gift cards.

FIG. 13A is an example of flow diagram illustrating the receipt, purchase and/or registration of a gift card by a consumer.

FIG. 13B is an example of a flow diagram illustrating an example of an interest bearing gift card implementation.

FIG. 14 is an example of a user interface that may be implemented to display a gift card exchange system and gift card balance check interface.

FIG. 15 is a flow diagram illustrating an example of the operation of one implementation of a gift card exchange program.

FIG. 16 is an example of a user interface that may be implemented to display various loyalty programs in which a consumer is participating and itemized details of a select loyalty program.

FIG. 17 is an example of a flow diagram illustrating consumer enrollment in a loyalty program and the update of information related to the loyalty program.

FIG. 18 is an example of a user interface that may be implemented to display a targeted offer sent to the user in response to the user completing a travel calendar.

FIG. 19 is an example of a flow diagram illustrating the delivery of special offers and savings to target consumer in response to the completion of an event or travel calendar.

FIG. 20 is an example of a user interface that may be implemented for use by a consumer and which provides a consumer with the ability to have targeted offers send to the consumer's personal system account via a short message service text message.

FIG. 21 is an example of a flow diagram illustrating the delivery of special offers and savings to consumer upon the receipt of a short message service text message.

FIGS. 22A-22D are examples of user interfaces that may be implemented for use by a consumer and which provide rebate program options to the consumer.

FIG. 23 is an example of a flow diagram illustrating consumer auto enrollment in a loyalty program after the consumer has submitted a rebate form.

FIG. 24 illustrates an embodiment of an instant rebate management system 2400.

FIG. 25 illustrates an embodiment of an activation method 2500.

FIG. 26 illustrates an embodiment of an activation system 2600.

FIG. 27 illustrates an embodiment of an instant rebate management method 2700.

FIG. 28 illustrates an embodiment of subroutine 2800.

FIG. 29 illustrates an embodiment of a setup method 2900.

FIG. 30 illustrates an embodiment of a selection method 3000.

FIG. 31 illustrates an embodiment of a program login method 3100.

FIG. 32 illustrates an embodiment of a validation method 3200.

FIG. 33 illustrates an embodiment of a product manager method 3300.

FIG. 34 illustrates an embodiment of a verification method 3400.

FIG. 35 illustrates an embodiment of a rebate fulfillment association method 3500.

FIG. 36 illustrates an embodiment of an activation login component method 3600.

FIG. 37 illustrates a system 3700 in accordance with one embodiment.

### DETAILED DESCRIPTION

In the following description of preferred embodiments, reference is made to the accompanying drawings that form a part hereof, and which show, by way of illustration, specific embodiments in which the disclosure may be practiced. Other embodiments may be utilized and structural changes may be made without departing from the scope of the present disclosure.

### I. Targeted Marketing and Consumer Resource Management

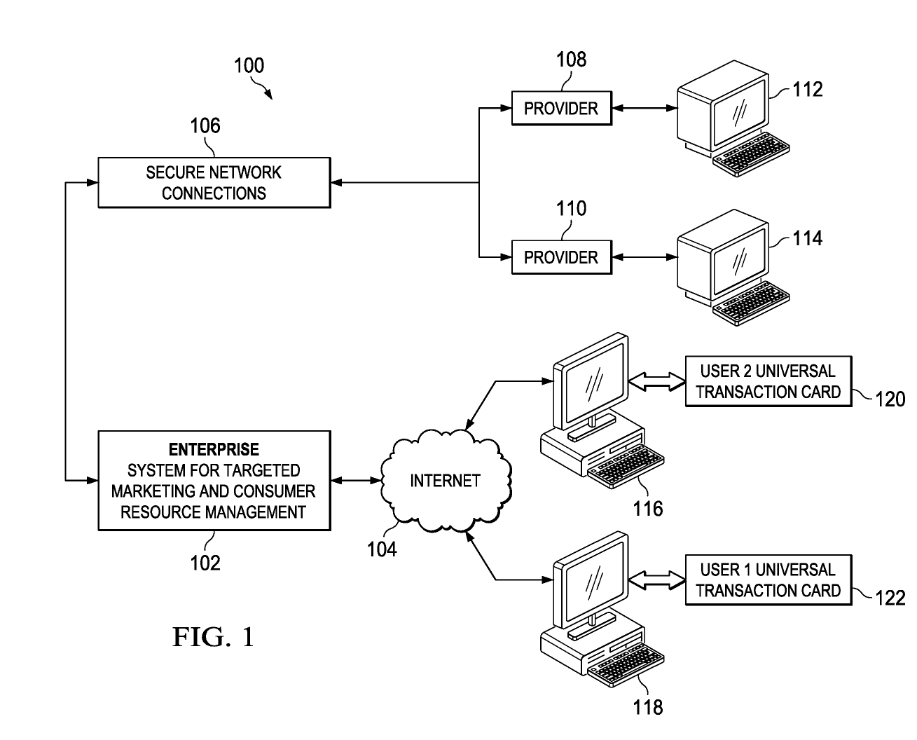

All of, or a portion of, the systems described below may be implemented on any particular machine (or machines), e.g., any particular electronic component (or electronic components), with sufficient processing power, memory resources, and throughput capability to execute specific programming and or instructions encoded on non-transitory computer readable media and to the handle the necessary workload placed upon the computer, or computers. FIG. 1 is a schematic diagram of an example system 100 for providing consumer resource management and targeted marketing. The system 100 includes an enterprise infrastructure 102 operable to communicate over the Internet 104 and over secure network connections 106, which may include connections over the Internet 104 or over any suitable wide-area network (WAN) (e.g. telecommunications networks). The enterprise infrastructure 102 may be operated by an enterprise offering targeted marketing to goods and services providers 108, 110, and consumer resource management services to consumers at network terminal 116, 118. The secured network connections 106 allow providers 108, 110 to securely connect to the enterprise infrastructure 102. The secured network connections 106 are secure in that the connections are private (for example, point-to-point, or virtual private network connections), restricted access connections. The providers 108, 110, retailers in particular, may use Point-of-Sale (POS) terminals 112, 114, which may connect to the enterprise infrastructure 102 over the secured network connections 106. The Internet 104 provides access to the enterprise infrastructure 102 to consumers using network terminals 116, 118. The network terminals 116, 118 may include personal computers, laptops, handheld devices, mobile phones, or any other computing device capable of running World-Wide Web client applications (e.g. web browsers).

The example system 100 shown in FIG. 1 depicts POS terminals 112, 114 as the retailers' source of interaction with the enterprise infrastructure 102. Other types of terminals may be used instead, such as network terminals (similar to network terminals 116, 118), which may include PCs, laptops, handheld devices, mobile phones, or other devices. Network terminals may, for example, be made available in Kiosks to provide retailers access to the enterprise infrastructure 102.

The providers 108, 110 in the system 100 in FIG. 1 may include retailers, service providers, and manufacturers that may or may not have a commercial presence on the Internet 104. The retailers, service providers and manufacturers that have a commercial presence on the Internet 104 may provide product distribution channels to allow consumers to purchase goods on-line and consumer services that ease and enhance the consumer's on-line shopping experience. The product distribution channels may include a web-site that allows credit card transactions, secured bank account access, and account information to individual consumers that have accounts with the providers 108, 110. The providers 108, 110 may also include banks through which consumers may access funds.

In the system 100 in FIG. 1, the providers 108, 110 may be in a business relationship (e.g. contractual) with the enterprise operating the enterprise infrastructure 102 that permits configuration of electronic commercial access to the partners via the enterprise infrastructure 102. The providers 108, 110 may be retailers that collect data from the POS terminals 112, 114 relating to purchases made by consumers at the retailer's stores. The providers 108, 110 may be manufacturers that may use the enterprise infrastructure 102 as a product distribution channel, or as a source of information for targeted marketing. Providers 108, 110 having a business relationship and using services with the enterprise infrastructure 102 are also referred to as “partners” in this description.

The enterprise infrastructure 102 may work with consumers as members, subscribers, or consumers having an account with the enterprise infrastructure 102. Consumers may access, configure and use tools available on a consumer front-end interface to their accounts. The consumers may purchase gift cards or configure a universal transaction identifier 120, 122 to represent those gift cards having a balance for making purchases associated with it (gift cards may be physical gift cards embodied in tangible objects or electronic stored-value cards represented by an electronic identifier which may be digitally transmitted and transferred). The universal transaction identifier 120, 122 may be similar to a gift card. However, while gift cards are made for purchases from specific retailers, service providers or manufacturers; the universal transaction identifier 120, 122 may be configured to permit a consumer to purchase goods from different providers 108, 110. The POS terminals 112, 114 may be equipped with a universal transaction identifier 120, 122 reading device to associate the universal transaction identifier 120, 122 with a consumer account in the enterprise infrastructure 102. The consumer account may include data relating to the partners 108, 110 from which goods may be purchased and balances or limits on the gift card amounts that may be used for purchasing goods from each partner 108, 110.

It is noted that the universal transaction identifier 120, 122 includes identifying information that is keyed to the consumer's account in the enterprise infrastructure 102. The identifying information is recorded on the magnetic strip of the universal transaction identifier (card) 120, 122 similar to a credit card. The identifying information may however be stored on something other than a card such as, a radio frequency identifying transmitter (RFID), a barcode, or any other suitable form. The identifying information may also be a thumbprint image that may be compared with a consumer's thumbprint image that may be scanned at the POS terminal 112, 114 or any other biometric identifier. In addition, access to the system may also be accomplished using an identification proxy such as a user's telephone number or some other means of unique identification.

For purposes of this application, a universal transaction identifier may be also be referred to as universal transaction card, neither of which require the use of a physical card to function as an identifier. Both a universal transaction identifier and universal transaction card shall mean any mechanism for identifying a consumer and associating such identification with a consumer's account in the enterprise infrastructure 102. Further, when referencing the purchase or use of a universal transaction identifier or universal transaction card, it is not required that the purchase of any physical structure be made to function as a universal transaction identifier and universal transaction card.

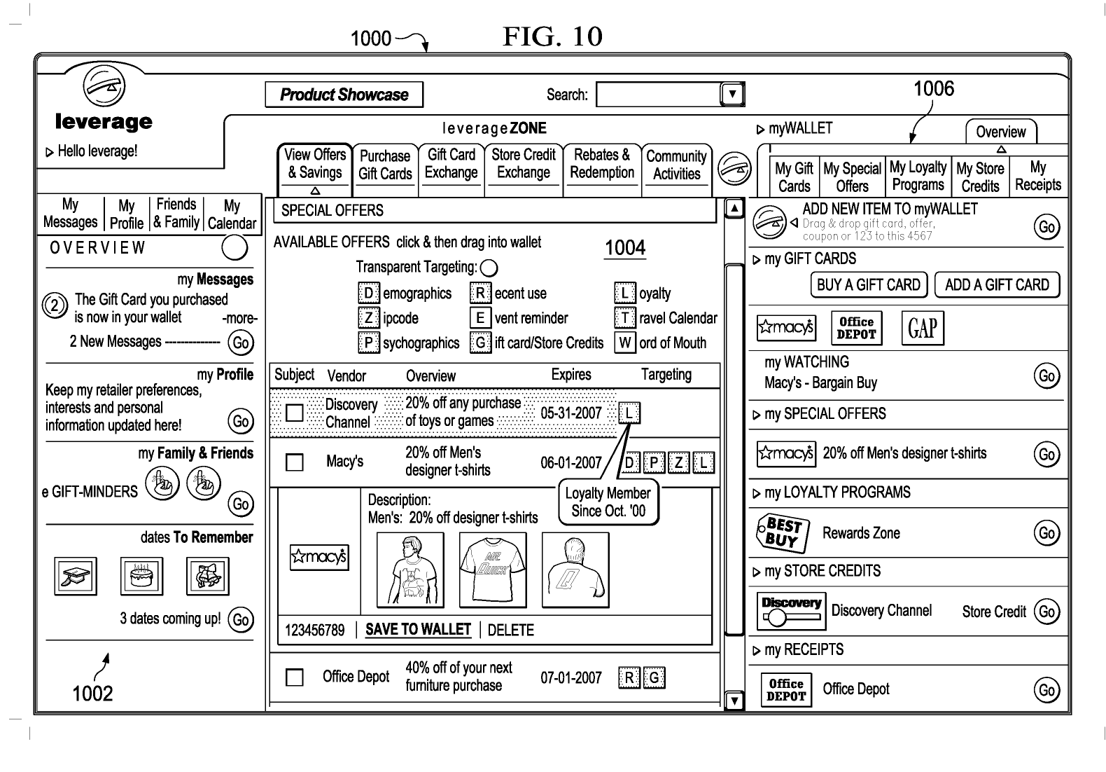

The consumers may interact with the enterprise infrastructure 102 using a client application that connects to consumers' accounts with tools for assisting the consumer in managing consumer resources. The client application provides the consumer front-end to the enterprise infrastructure 102. At the consumer front-end, the consumer may perform functions such as: purchase gift cards, swap gift cards, track balances, subscribe to and manage loyalty programs, track offers and coupons from partners, store and sort receipts, rebate redemption and tracking, and other functions as described in more detail below with reference to FIGS. 10-23.

The enterprise infrastructure 102 may include a system network for performing a variety of services for both providers 108, 110 and consumers. The system network includes applications that provide the tools available to consumers on the consumer front-end and database storage systems for storing information relating to consumers and their accounts and for storing information relating to providers. The system network also includes hardware and software for implementing security measures to protect consumers' data as well as system data.

In an example system for targeted marketing and consumer resource management such as the system 100 in FIG. 1, the enterprise infrastructure 102 provides consumers with a website (or App-accessible platform) having tools, features, functions and applications that allow consumers to manage their consumer resources and to also purchase, or obtain, and swap gift cards 120, 122. As described in more detail below with reference to FIGS. 10-23, the tools include a personal profile section, a features section, and a personal resource management section. The personal profile section allows a consumer to store information that would assist the consumer in making shopping and purchasing decisions, and that will assist in providing the consumer with targeted offers and savings and in controlling the volume and frequency of communication from Retailers. Among other features, the features section provides a consumer with tools for purchasing gift cards and swapping the cards for purchases at other stores and participating in an enhanced rebate program. The features section also provides lists of offers and savings targeted for the consumer according to various targeting mechanisms (e.g. demographics, zip code, psychographics, loyalty, etc.), which may be provided to the user. The features section also allows consumers to engage in a transaction to swap or trade gift cards with other consumers. The personal management section provides tools that allow the consumer to manage gift cards, special offers, loyalty programs, retailer credit card accounts, receipts and rebates.

The system 100 provides providers 108, 110 with focused access to consumers. Providers 108, 110, as partners with the enterprise, may target advertisement, offers, coupons and other information about their products and services to consumers who generate data used by the partners through their access via the consumer front-end. Providers 108, 110 thus obtain a more focused audience for their advertisement and information relating to the success or failure of their advertising campaigns. Providers 108, 110 also obtain more precise information regarding the ownership and use of their gift cards, including via the consumers' use of a universal transaction identifier. Provides 108, 110 may also target markets, and track consumer spending across multiple channels such as marketing (online, offline, direct marketing, etc.) and sales (B&M retailers, online retailers), both online and offline.

### II. Enterprise Infrastructure

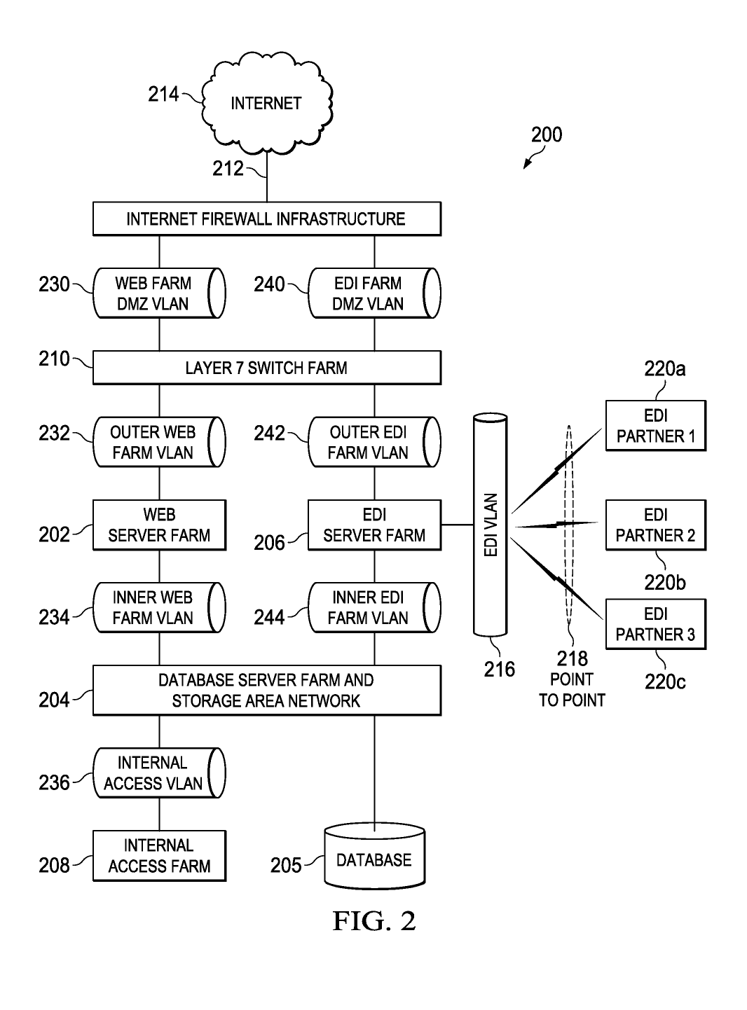

FIG. 2 is a block diagram of an example system network 200 that may be used to implement an example of the system in FIG. 1. Those of ordinary skill in the art will appreciate that the system network 200 in FIG. 2 is described to illustrate one example of a network that may be used to implement the system described above with reference to FIG. 1. Many other network architectures not described here may be used as well. The system network 200 includes a web server farm 202, a database server farm 204, an electronic data interchange (EDI) farm 206, and an internal access server farm 208. The system network 200 includes a layer 7 switch farm 210 and an Internet firewall infrastructure 212 to implement a consumer front-end over the Internet 214. The consumer front-end may be implemented as a site on the World Wide Web. The system network 200 also includes an EDI virtual local area network (VLAN) 216 with point-to-point connections 218 to EDI partners 220a, 220b, 220c.

In general, the system network 200 in FIG. 2 includes remote and local infrastructure. Connectivity to the system network 200 may be provided by co-location facilities hosting the remote infrastructure. Remote infrastructure includes servers, routers, databases and other network entities that are geographically distributed as needed to provide access to partners and to consumers. The remote infrastructure includes devices that may fall under a functional class and may be distributed in the system network 200 as a farm (e.g. web server farm, EDI server farm, etc.). Local infrastructure may include servers, routers, databases and other network entities that provide limited, primarily internal access within the system for targeted marketing and consumer resource management. Local infrastructure may also be geographically distributed with access limited by network design (e.g. completely internally accessed databases may be maintained within an Intranet).

The system network 200 in FIG. 2 implements a logical separation of server systems based upon type and manner of access. This introduces multiple layers of access, and in turn, provides a deeper layer of security, even within the system network 200. The system network 200 includes a general vertical depth of separation of service and levels of security allowing for several layers of access. The layers of access range from the consumer front-end (via the Internet 214), which is at the forefront and has the lightest layer of security, to a system data base 205, which is at the deepest layer of access and security.

The layers of access are implemented as virtual local area networks (VLANs) having no real access to one another except through routing done by routing modules on the network switches. Each VLAN may be configured appropriately to limit access according to the appropriate level of security. The levels of security correspond in general to four tiers of network entities: the presentation tier, the business logic tier, the data access tier, and the data tier.

At the top level of access (for the consumer front-end), the presentation tier is responsible for delivery of data to end clients outside of the enterprise infrastructure. The end clients may be consumers or partners 220a, 220b, 220c. In the presentation tier, data is formatted for communication with the business logic tier of applications that processes requests and handles data delivery to the client applications. Data in the presentation tier may be in XML format along with XSLT stylesheets to allow rendering by client applications. The presentation tier operations, generally, in a layer of servers from the web server farm 202 that resides in a DMZ (DeMilitarized Zone) network. These servers in the DMZ network may be accessed using a web farm DMZ VLAN 230 and the Layer 7 switch farm 210. The DMZ network servers operate as proxy servers between consumers and the enterprise infrastructure.

The next layer of access includes servers in the web server farm 202 that form the business logic tier. The business logic tier includes application code (Beans) that will handle requests from client applications (such as web browsers) and make requests to the Data Access Tier for relevant data. It will then process the data and deliver it for presentation to the client applications. The business logic tier is kept separate from interaction with consumers to preserve integrity of the applications and access to the database 205. Added security may be provided by an outer web farm VLAN 232.

In the next layer, the data access tier may make requests directly to the Data Tier (or the database 205). The data access tier may be separate from the business logic tier of applications to differentiate how the data is stored and how it is retrieved from certain platforms. Security may be configured with an inner web farm VLAN 234.

The data tier is in the last layer of security, which includes the database 205, and which has the tightest security to protect the most critical data. Security may be configured with an internal access VLAN 236.

The system network 200 includes a general horizontal separation of EDI partnerships, which are logical VLANs that separate access by each partner 220a, 220b, 220c to the infrastructure of the example system for targeted marketing and consumer resource management implemented using the system network 200. In general, a partner may access their own private VLAN at 216 and 218 into the system network 200 infrastructure through a VPN concentrator or routed through a routing module on the backbone switch. This structure may isolate potential security breaches from single partners 220a, 220b, 220c. It may also prevent any partner 220a, 220b, 220c from being able to access rival partner data from the system network 200.

The EDI partner access to the system network 200 may also be layered vertically according to level of security. An EDI farm DMZ VLAN 240 provides the lowest level of security at the consumer front-end for access to the EDI server farm 206. The outer EDI farm VLAN 242 provides a higher level of security at a business logic level similar to the business logic tier described above with reference to the web server farm 202. The highest level of security is provided at the inner EDI farm VLAN 244 for access to more critical data via the database server farm 204.

Connectivity to the system network 200 may be provided by co-location facilities hosting the remote infrastructure. Connectivity may be provided by Tier 1 Internet Backbone providers to ensure access to most networks without having to transcend networks in order to provide the shortest network path from Leverage Consumer to Leverage Infrastructure. Besides utilizing connectivity to Tier 1 providers and managing complex BGP routes to the Internet Backbone, a backup connection to InterNAP will also be established.

In the example system for targeted marketing and consumer resource management, the complex backbone connections force the infrastructure to appear “local” to the consumers accessing the system network 200 via their host ISPs. This prevents the consumer from transcending networks between peer networks and eventually experience degraded network performance.

A. Web Server Farm

The web server farm 202 includes two banks of servers for serving either static or dynamic content. Each bank may be designated as either the static web farm or the dynamic web farm. The static web farm may service client requests for static content that is neither database generated nor does it use any type of server content processing and generation before being transmitted through the Internet to the client applications (e.g. web browser). Such examples of content would be images, video, or web templates. The dynamic web farm may be designed to serve dynamic content generated in multiple ways, whether that is done via XML/XLS transformation, server-side scripting, or through middle-tier applications that directly interfaces with the database 205.

The web server farm 202 may be implemented using any suitable hardware and software systems implementing server functions. In one example implementation, the web server farm 202 is implemented with Sun multiprocessor blade servers running either the Solaris™ operating system or Red Hat Linux Enterprise™ operating system. The example implementation of the web server farm 202 also includes the Zeus™ Web Server (ZWS) application. Like the Apache™ Web Server application, the ZWS is a robust, commercial-grade, full-featured and highly efficient web server software. However, ZWS is multi-threaded to leverage the symmetric multiprocessing nature of multi-cored hardware platforms, which increases the response times and load servicing for client requests. The web server farm 202 will also house the Java™ application server software that operates the applications to service consumer requests on the enterprise website. The Java™ Application Server software may be a combination of Apache Tomcat for simple java applications and JBoss Application Server software for J2EE applications.

It is to be understood that specific implementations of the web server farm 202 may use any suitable hardware and software systems. The hardware and software systems described above are merely examples of the types of hardware and software systems that may be used.

B. Database Server Farm

The database server farm 204 may store data specific to consumer front-end interactions and the EDI partner data collected from partners 220a, 220b, 220c. The database server farm 204 may be implemented using any suitable hardware and software systems configured to operate as database servers. In one example implementation, the database server farm 204 is implemented using Sun multiprocessor Enterprise servers banked with multi-core processors and full redundant power and mirrored drives for the operating system and database application. Depending upon the nature of the application and the database 205 that is needed to interface against such applications, the database server farm 204 may run either the Oracle Database Server product or the MySQL Database server product. Also, depending upon the nature of the data that is being stored, highly complex relational database tables may use Oracle while simplistic database schemas may use MySQL. The database server applications may be clustered to ensure high availability and fault tolerance. This will also provide application load balancing among the database server farm 204.

The database 205 for the database server farm 204 may reside in a SAN (Storage Area Network) solution that will offer both high availability and fault tolerance.

It is to be understood that specific implementations of the database server farm 204 may use any suitable hardware and software systems. The hardware and software systems described above are merely examples of the types of hardware and software systems that may be used.

C. EDI Farm

The EDI (Electronic Data Interchange) farm 206 may be designated in the system network 200 to communicate with partners 220a, 220b, 220c. The EDI farm servers 206 may have different applications and permissions from the web server farm 202 to access and process, as well as store, data within the database farm 204. The nature of the applications operating on the EDI farm servers 206 may have more direct access to the database 205 to increase efficiency in data processing and storage. The EDI farm servers 206 may reside in a private VLANs (Virtual Local Area Networks) that can only be accessed via VPN (Virtual Private Network) Concentrators or through specific Point-to-Point access into the VLAN as shown at 216 and 218.

The EDI farm servers 206 may be implemented using any suitable hardware and software system configured to operate server functions. In an example implementation, the EDI server farm 206 is implemented using the same platform as that of the web server farm 202 or by running IBM Mainframes. The EDI farm servers 206 software in the example implementation may also be similar to that of the web server farm 202 software. If the EDI farm servers 206 include IBM Mainframes, then the hardware will run IBM AIX operating systems, and the EDI farm servers 206 will run IBM Websphere Application Server software.

It is to be understood that specific implementations of the EDI server farm 206 may use any suitable hardware and software systems. The hardware and software systems described above are merely examples of the types of hardware and software systems that may be used.

D. Internal Access

The internal access farm servers 208 may also resemble the web server farm 202 in platform, software, and resource architecture. However, like the EDI farm servers 206, the applications will be tailored for internal access from an enterprise Intranet. Such applications may include data mining and statistical information for marketing and sales.

### III. Partner Interfaces to the Enterprise Infrastructure

A. Retail Partner Infrastructure

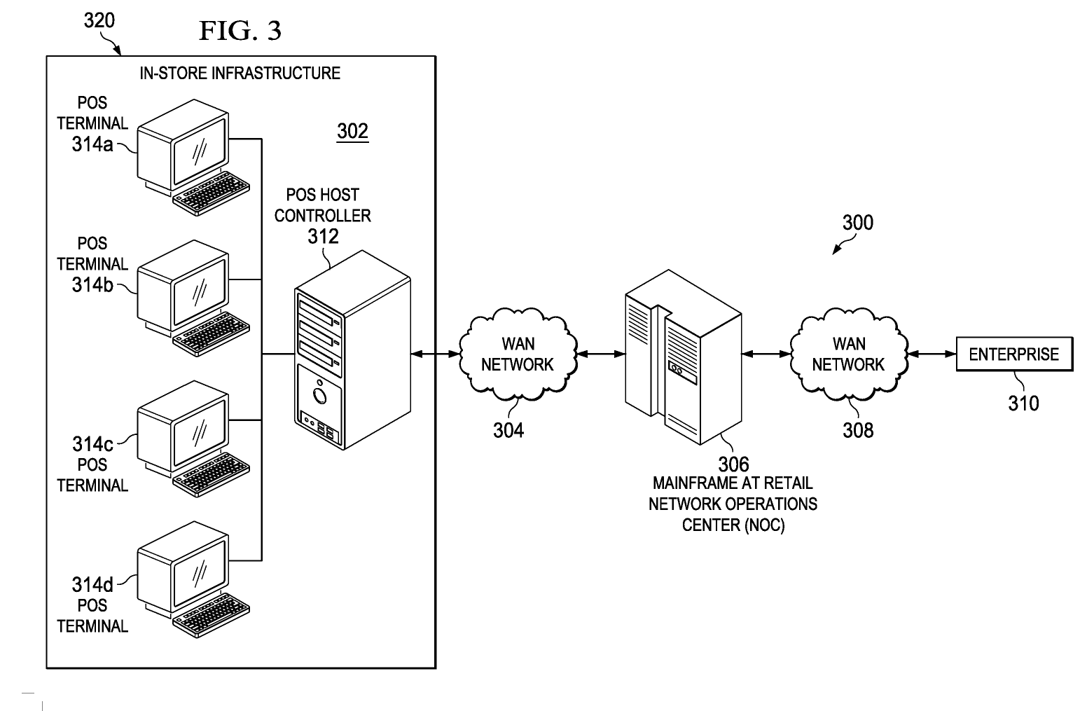

The retail partner infrastructure provides partners with connectivity to the enterprise infrastructure 100 (in FIG. 1). The implementation of the retail partner infrastructure for any given retail partner may depend on the computer network system connecting the retail partner's point-of-sale terminals in the partner's stores. Some partners may operate with large, functionally rich computer networks, and others may have smaller, more basic computer systems. FIGS. 3-5 depict three general configurations of retail partner infrastructures.

FIG. 3 is a schematic diagram depicting one example of a retail partner infrastructure 300. The retail partner infrastructure 300 includes an in-store infrastructure 302, a first WAN interface 304, a retail network operations center (NOC) 306, a second WAN interface 308, and an enterprise infrastructure 310. The in-store infrastructure 302 includes a POS host controller 312 connected to the first WAN interface 304 and to POS terminals 314a-d. At each retail partner location 320, transactions processed at each POS terminal 314a-d may be communicated to the host controller 312. In FIG. 3, each retail partner location 320 is networked to a central or semi-central infrastructure that consolidates data and manages both internetworking and intranetworking traffic but also EDI partner traffic. The central infrastructure in the retail partner infrastructure 300 is the NOC 306. The host controller 312 may collect the data associated with each transaction from each POS terminal 314a-d and communicate the data to the NOC 306.

Consumers may purchase goods at the retail partner location 320 using gift cards via swiping their universal transaction identifier 120 (in FIG. 1) at one of the POS terminals 314a-d. The POS terminal 314a-d may be equipped with a card reader, such as a credit card reader, for sensing the information on the universal transaction identifier. In a transaction, the consumer may offer the universal transaction identifier to the salesperson at the retail partner location 320. The universal transaction identifier may be read by the card reader at the POS terminal 314a-d to determine the appropriate consumer account. The identifier is communicated, along with the purchase price of the article being purchased and any other relevant data (e.g. an identifier for the article being purchased), to the host controller 312, which communicates the universal transaction identifier and purchase price to the enterprise infrastructure 310.

At the enterprise infrastructure 310, an appropriate application for the retail partner processes the transaction by looking up an account associated with the universal transaction identifier. The account is checked to determine if the balance associated with any gift cards relating to the retail partner is sufficient to cover the transaction. If the balance is sufficient, and the consumer chooses to use the balance, the transaction is processed and recorded. The balance associated with the retail partner gift card represented by the universal transaction identifier is reduced accordingly. Other functions may be performed during the transaction before it is finalized at the POS terminal 314a-d, including transmitting data regarding offers and savings relating to the transaction and the use or accrual of rewards associated with a loyalty program.

The retail partner infrastructure 300 leverages the existing network infrastructure setup between each retail location 320 to the corporate office's NOC 306. Data may be channeled through the NOC 306 to establish a network path providing a central point of contact into the enterprise infrastructure 308. In the retail partner infrastructure 300 in FIG. 3, the partnership may be managed at a single point to ease integration and management.

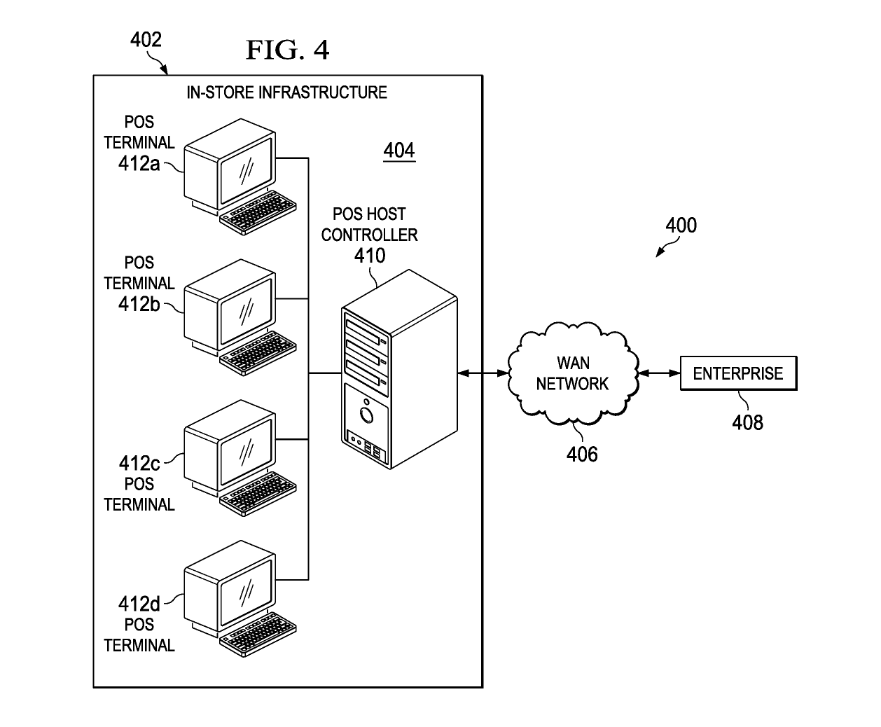

FIG. 4 is a schematic diagram depicting another example of a retail partner infrastructure 400. In the retail partner infrastructure 400, each retail location 402 operates independently using an in-store network 404 having a POS host controller 410 connected to a plurality of POS terminals 412a-d and a WAN network 406, which provides connectivity to an enterprise infrastructure 408. Data consolidation and accounting may be performed in the same host controller 410.

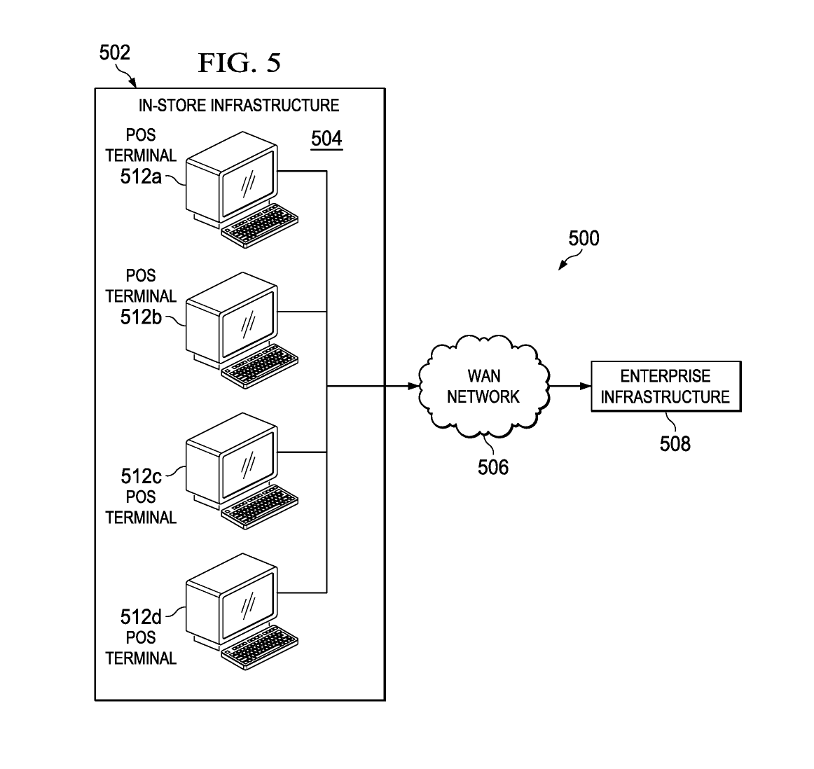

FIG. 5 is a schematic diagram depicting another example of a retail partner infrastructure 500. The retail partner infrastructure 500 in FIG. 5 includes an in-store network 504 in each store 502. The in-store network 504 includes a plurality of POS terminals 504 connected to a WAN network 506, which provides connectivity to an enterprise infrastructure 508. The retail partner infrastructure 500 may establish an EDI relationship either at each POS Terminal 512a-d or through an in-store POS Host Controller (not shown). This may include building interfaces into either the POS Terminal 512 or POS Host Controller or both. Connectivity may be established either by a point-to-point line or via the Internet using a VPN gateway setup either to Host Controllers or to Retail Partner NOC (Network Operation Center) infrastructure.

### IV. POS Terminal Interfaces

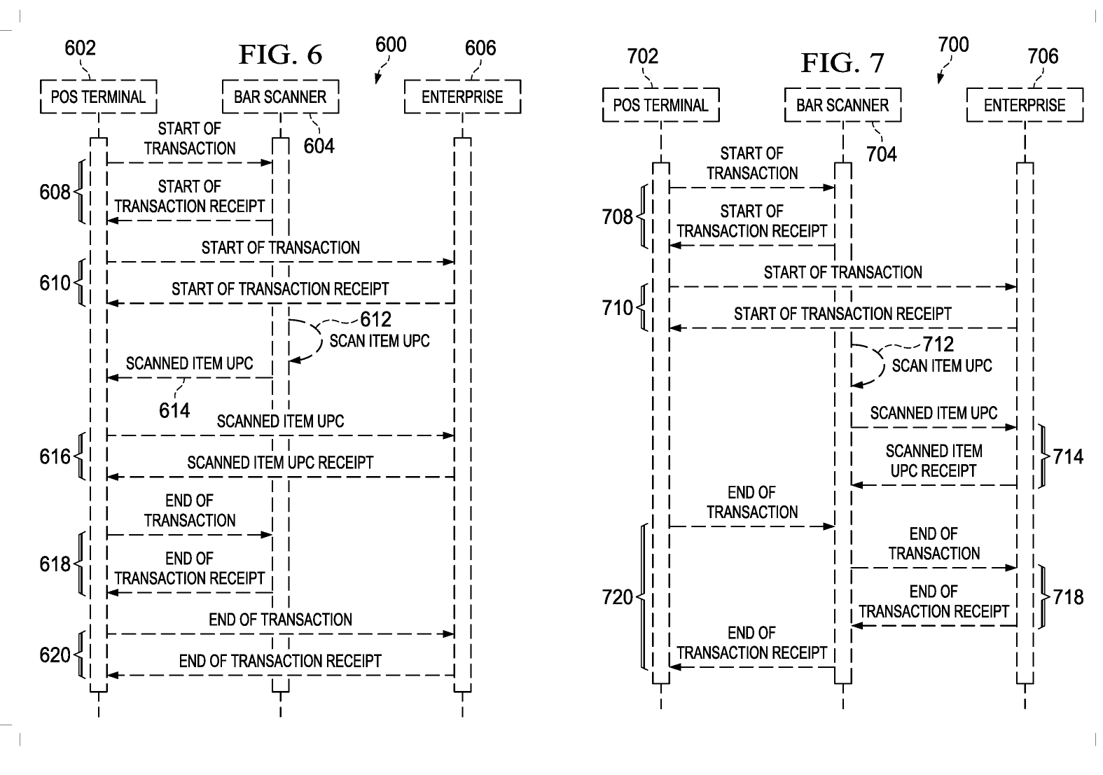

As described above with reference to FIG. 3, a consumer using a universal transaction identifier may make purchases that may be processed at the POS terminals 314a-d. FIGS. 6-8 depict operation of examples of POS terminal interfaces to the enterprise infrastructure illustrating how data on consumer purchasing behavior may be collected and made available to partners. POS terminal interfaces that may be implemented include, but are not limited to: Scanner Interface; Magnetic Stripe Reader (MSR) Interface; PIN Pad Interface; and POS Application Interface.

Of the 4 most common enterprise infrastructure interfaces, three are interfaces to a hardware device. The remaining enterprise infrastructure application interfaces against the enterprise infrastructure at the application or higher level.

FIG. 6 is a flow diagram depicting operation of an example of a POS terminal 602 that includes a barcode scanner 604 for UPC or SKU barcodes on goods being purchased for communication to an enterprise infrastructure 606. The POS terminal 602 includes a computer terminal having a typical human interface for processing commercial transactions. While the barcode scanner 604 is shown as a separate component in FIG. 6, the barcode scanner 604 or other universal transaction identifier reader may be viewed as an integral part of the POS terminals shown in FIGS. 1-5.

Referring to FIG. 6, a salesperson in a retail partner location (store) may initiate a transaction at the POS terminal 602. The POS terminal 602 may, in response, send a message indicating a start of the transaction to the barcode scanner 604 at 608. The barcode scanner 604 receives the message and performs initialization steps and indicates a readiness to scan a barcode by sending a receipt message to the POS terminal 602 at 608. The POS terminal 602 also sends a message indicating start of a transaction to the enterprise infrastructure 606 at 610. The message at 610 may be sent over a retail partner infrastructure such as the example retail partner infrastructures described above with reference to FIGS. 3-5. The enterprise infrastructure 606 may respond with start of transaction receipt at message 610. At 612, the sales person may, using the barcode scanner 604, scan the UPC or SKU causing the UPC or SKU data to be communicated back to the POS terminal 602 at 614. The POS terminal 602 may send the UPC or SKU data to the enterprise infrastructure 606 at 616 and wait for a scanned item UPC receipt. When the receipt is received, the POS terminal 606 may send a message at 618 to the barcode scanner 604 indicating the end of the transaction and wait for a receipt. The barcode scanner 602 may then send a message indicating the end of the transaction to the enterprise infrastructure 606 and wait for a receipt at 620.

FIG. 7 is a flow diagram depicting operation of another example of a first POS terminal. The example in FIG. 7 uses a barcode scanner 704 as well. A salesperson in a retail partner location (store) may initiate a transaction at the POS terminal 702. The POS terminal 702 may, in response, send a message indicating a start of the transaction to the barcode scanner 704 at 708. The barcode scanner 704 receives the message and performs initialization steps and indicates a readiness to scan a barcode by sending a receipt message to the POS terminal 702 at 708. The POS terminal 702 also sends a message indicating start of a transaction to the enterprise infrastructure 706 at 710. The message at 710 may be sent over a retail partner infrastructure such as the example retail partner infrastructures described above with reference to FIGS. 3-5. The enterprise infrastructure 706 may respond with start of transaction receipt at message 710. At 712, the sales person may, using the barcode scanner 704, scan the UPC or SKU causing the UPC or SKU data to be communicated to the enterprise infrastructure 706 at 714. After receiving a transaction receipt, the POS terminal 702 may send a message at 716 to the barcode scanner 704 indicating the end of the transaction and wait for a receipt. The barcode scanner 702 may then send a message indicating the end of the transaction to the enterprise infrastructure 706 and wait for a receipt at 718. The barcode scanner 704 may then send a message indicating end of the transaction to the POS terminal 702 at 720.

The flow diagrams 600 and 700 in FIGS. 6 & 7 illustrate how the enterprise infrastructure 606, 706 may collect information about products purchased by consumers. The interface that implements the flow diagrams 600, 700 may interact with the barcode scanner devices 604, 704 at retail stores. These scanners may be, generally, hand-held scanners or bed scanners. Examples of such scanners include combination scanners and scales at grocery stores or hand scanners at department stores.

The enterprise infrastructures 606, 706 may distribute an application that runs on each POS terminal 602, 702 and “attach” to the scanner devices 604, 704. The enterprise infrastructure 606, 706 may then “listen” on each item scan and collect the UPC bar code or SKU information for each item. By capturing this information, the enterprise infrastructure 606, 706 may record each item purchased by the consumers.

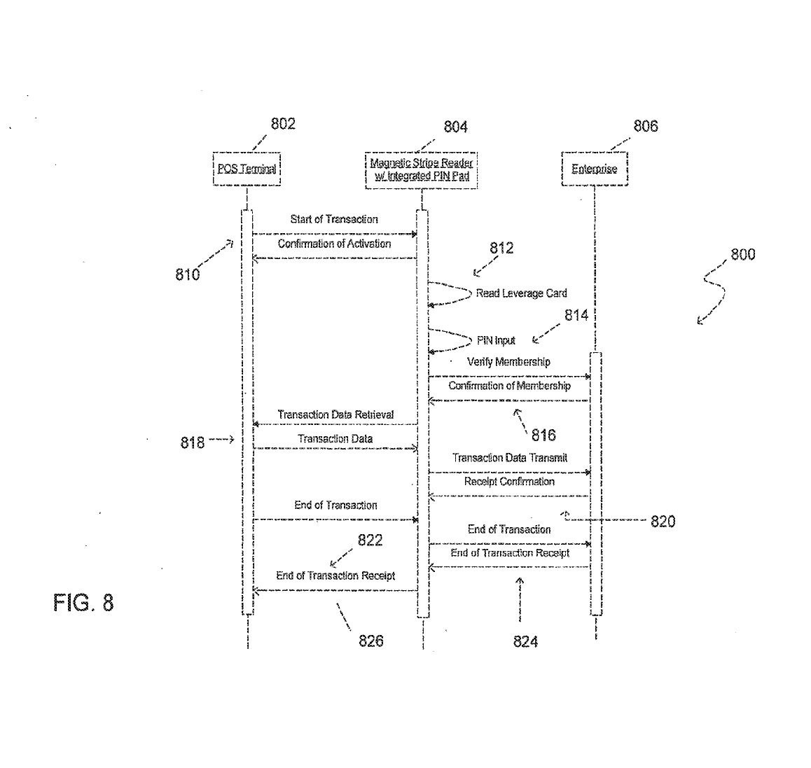

FIG. 8 is a flow diagram depicting operation of another example of a POS terminal 802 that incorporates a magnetic strip reader with integrated PIN pad 804. The Magnetic Stripe Reader (MSR) 804 may interact with the MSR devices generally found either attached to pin pad devices for ATM authentication or built into the POS terminal 802. The enterprise infrastructure 806 may distribute an application to run on each POS terminal 802 or pin pad device that will “attach” to the MSR device 804. The enterprise infrastructure 806 may collect data from each swipe of a magnetic card, such as the universal transaction identifier in order to authenticate membership of a purchasing consumer. This will also enable identification of the consumer subscriber to the enterprise infrastructure 806 for the particular in-store purchase transaction.

The PIN pad interface of the magnetic strip reader 804 in FIG. 8 interacts with the PIN pad devices that are used to authenticate electronic payment transactions (EPT) at the POS terminal 802. Typically, the PIN pad devices include a display with keys and may or may not be integrated with the magnetic strip reader 804. The enterprise infrastructure 806 may distribute an application to run on either the POS terminal 802 or the pin pad device on the magnetic stripe reader 804. A consumer member, or consumer, of the enterprise infrastructure 806 may be assigned a PIN that may be used with the universal transaction identifier. The application allows the enterprise infrastructure 806 to authenticate the consumer against its database and authorize the consumer the exclusive use of the universal transaction identifier and benefits stored within.

Referring to FIG. 8, a salesperson may begin a transaction at the POS terminal 802, which signals a start of transaction message to the magnetic strip reader 804 at 810. The magnetic strip reader 804 initializes and sends back a confirmation message at 810, then waits for the magnetic strip input. At 812, the universal transaction identifier (card) is passed through the magnetic stripe reader 804. The magnetic strip reader 804 display requests input of a PIN at the PIN pad. At 814, the consumer enters her assigned PIN. At 816, the magnetic stripe reader 804 sends the PIN and other identifying information to the enterprise infrastructure 806 for verification of membership and waits for a confirmation. When the confirmation of membership is received by the magnetic stripe reader 804, the magnetic stripe reader 804 may request transaction data from the POS terminal 802 (which may include the UPC data retrieved with the barcode scanner as described above with reference to FIGS. 6 and 7). At 818, the transaction data is requested and received at the magnetic stripe reader 804. At 820, the magnetic stripe reader 804 sends the transaction data to the enterprise infrastructure 806. The magnetic stripe reader 804 may receive a message signaling the end of the transaction from the POS terminal 802 at 822. The magnetic stripe reader 804 transmits the end of transaction message to the enterprise infrastructure 806 at 824 and waits for an end of transaction receipt message. At 826, the magnetic stripe reader 806 communicates the end of transaction receipt message to the POS terminal 802 to complete the transaction.

FIGS. 6-8 describe operation of interfaces that provide the enterprise infrastructure with access to transaction data when consumers use the universal transaction identifier. The transaction data collected during transactions includes: [0098] product information determined using the UPC or SKU at the barcode scanner; [0099] personal information determined using the identifier information accessed via the universal transaction identifier. The enterprise infrastructure may store the transaction data as part of the consumer's account information. The enterprise infrastructure may also offer retail partners research and information derived from the product information and from the personal information about the consumer. The retail partners may use the information to target advertisements, offers, savings, coupons, etc. to consumers that actually purchase their products, or are more likely to purchase their products.

Transaction data may also be collected and communicated by a POS application that may run on POS terminals or within the POS host controller 312 (in FIG. 3). The enterprise infrastructure may distribute the POS application, which may establish a custom EDI connector between the retail POS application and the enterprise infrastructure in order to capture a transaction log of any particular transaction. The POS application may also track or collect other POS specific data that is relevant to the retail POS application.

### V. Retail Partner Application Architecture

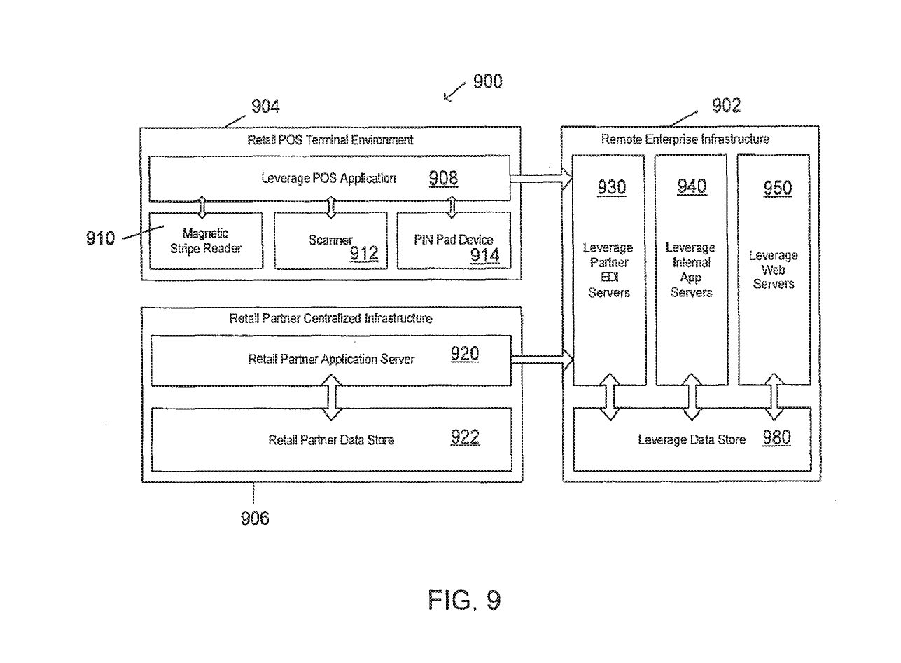

FIG. 9 is a block diagram of an example of an enterprise infrastructure and retail partner's interface 900 depicting interaction between the retail partners and the enterprise infrastructure. The enterprise infrastructure and retail partners' interface 900 includes a remote enterprise infrastructure 902, a retail PUS terminal environment 904, and a retail partner centralized infrastructure 906.

The retail POS terminal environment 904 includes components that may operate in POS terminals: a PUS application 908, a magnetic stripe reader (MSR) 910, a scanner 912, and a PIN pad device 914. The retail POS environment 902 may implement interfaces to the enterprise infrastructure 902 described above with reference to FIGS. 6-8. The POS application 908 may reside within each retail partner POS terminal 904 and interface with the MSR 910, scanner 912, and PIN pad devices 914. Upon each transaction, the transaction data collected by the POS application 908 may be transmitted in real-time to the enterprise infrastructure 902.

The data collected may be in multiple formats, depending upon the nature of the devices interfaced. The enterprise infrastructure 902 may support binary formats as well as default ASCII formats inherent to the devices. In one example, the data collected may be translated into XML for ease of transport and parsing.

The enterprise infrastructure 902 includes partner EDI servers 930, internal application servers 940, web servers 950, and a data store 980. The partner EDI servers 930 are the servers in the EDI server farm 206 described above with reference to FIG. 2. The internal application servers 940 are the servers in the internal app server farm 208 described above with reference to FIG. 2. The web servers 950 are the servers in the web server farm 202 described above with reference to FIG. 2. The data store 980 is the database 205 in FIG. 2.

As shown in FIG. 9, the enterprise infrastructure 902 communicates with the retail POS terminal environment 904 and with the retail partner centralized infrastructure 906. The retail partner centralized infrastructure 906 includes a retail partner application server 920 and a retail partner data store 922. The retail partner centralized infrastructure 906 may include the host controller 312 (in FIG. 3) connected via the retail NOC 306. The retail partner centralized infrastructure 906 may also be the host controller 412 or 512 (in FIGS. 4 and 5 respectively) in each retail store. The retail partner centralized infrastructure 906 may be an established EDI connector that interfaces between the retail partner application server 920 and the EDI servers 930.

The data collected may be in multiple formats, depending upon the nature of the devices interfaced. The enterprise infrastructure 902 may support binary formats as well as default ASCII formats inherent to the devices. In one example, the data collected may be translated into XML for ease of transport and parsing; specifically the NRF IXRetail POSLog format.

### VI. Consumer Front-End

FIGS. 10-23 illustrate various examples of user interfaces that may be implemented for the system 100 to interact with the consumer and examples of the operation of the system 100 as it may interface with the consumer. While the system 100 may be implemented in various forms for interaction with the consumer, the examples illustrated in FIGS. 10-23 show an on-line web-based program designed to interact with the consumer, distribute targeted marketing campaigns and manage consumer resources. Those skilled in the art will recognize that the system may be a software system that may be designed as one or more software modules. When the system is comprised of multiple modules, the modules may reside locally or may be remotely located from one another and in communication over a network, such as the Internet. Those skilled in the art will also recognize that the on-line web-based functionalities may also be provided to the consumer via a or smart device application (“App”).

FIG. 10 is an example of a user interface that may be implemented for use by a consumer and that provides targeted offers to particular consumers. As illustrated in FIG. 10, the consumer interface 1000 may include three main sections: (i) a personal profile section 1002; (ii) a features section 1004; and (iii) a personal management section 1006.

When a consumer desires to join as a system member, the consumer will be prompted to enter basic personal information into the system, which can later be displayed and modified by accessing the personal profile section 1002 of the consumer's personal account. In particular, the consumer will be asked to provide basic profile information, including, but not limited to, demographic information, such as age, gender, zip code preference information regarding consumer likes and dislikes and information about friends and family for whom the consumer may purchase gifts or items. As illustrated in FIG. 10, the personal profile section 1002, may be segregated into subsections of information, which may include, for example, a message center, a profile section, a friends and family section, a dates to remember section, and an event and travel calendar section (not shown). Those skilled in the art will recognize that other types of information may be gathered from a consumer to assist with targeted marketing and management of consumer purchases, including but not limited to, consumer financial information and purchasing method information, such as credit card and shipping information. Moreover, the system provides an auto-populate functionality that, if enabled by the consumer, will automatically provide information from a stored database file, e.g., consumer identification, demographic, or authentication information, to forms, websites, or other electronic requestors to facilitate and expedite consumer activities, e.g., rebate application submissions. Such information may be presented in any numbers of ways and should not be limited to the information or presentation of information as illustrated in FIG. 10.

In the illustrated example, the consumer, via the features section 1004 of the consumer interface may view offers and savings, may purchase gift cards, may exchange gift cards, may exchange store credit, may initiate and track rebate redemptions, among other things. Further, in the illustrated example, the consumer, via the personal management section 1006, may view his/her personal gift cards and special offers marked as being of particular interest. Additionally, through a consumer's personal management section 1006, the consumer may view his/her participating loyalty programs and rewards earned, his/her available store credits and digital receipts from recent purchase from participating retailers.

As will be described further below in connections with FIGS. 10-23, the system 100 may be designed to interact with the consumer via an on-line web-based software program or smart device application (and “App”) and may include a number of different functions and features, which may include, but not be limited to, (a) an offer and savings feature; (b) gift card purchase feature; (c) gift card registration feature; (d) a gift card exchange feature; (e) a loyalty programs enrollment and management feature; (f) an event and travel offer and savings feature; (g) a short message services offer and savings feature; (h) a digital receipts feature; and (i) an enhanced rebate and marketing program feature. Further, in the example provided in FIG. 10, such features may be accessible either via the features section 1004 or the personal management section 1006 of the consumer interface.

The gift cards may be combined and accessed via a single universal transaction identifier (described above with reference to FIG. 1). The user may configure the universal transaction identifier to operate as a gift card accepted by multiple retailers, service providers or manufacturers.

A. Offers and Savings Feature

As illustrated in FIG. 10, a consumer may receive targeted marketing campaigns in the form of offers and savings or other information as part of the consumer's participation as a system 100 member. In the illustrated example, such offers and savings appear as expandable line-items listed in the features section 1004 of the consumer interface 1000 under the “View Offers & Savings” tab. Each offer may identify the vendor, provide a description of the offer, an expiration date and identify the targeting method utilized to prompt the consumer to receive each offer. The system may be designed such that the content of the offer may include one or more of the following types of content: text, video, pictures, service provider, retailer or manufacturer branding, web-links, voice, or other data types. Furthermore, the consumer may be provided with the option of selecting offers of interest and saving those offers into the consumer personal management section 1006 of the consumer interface, which activates an offer to be available for use by the consumer.

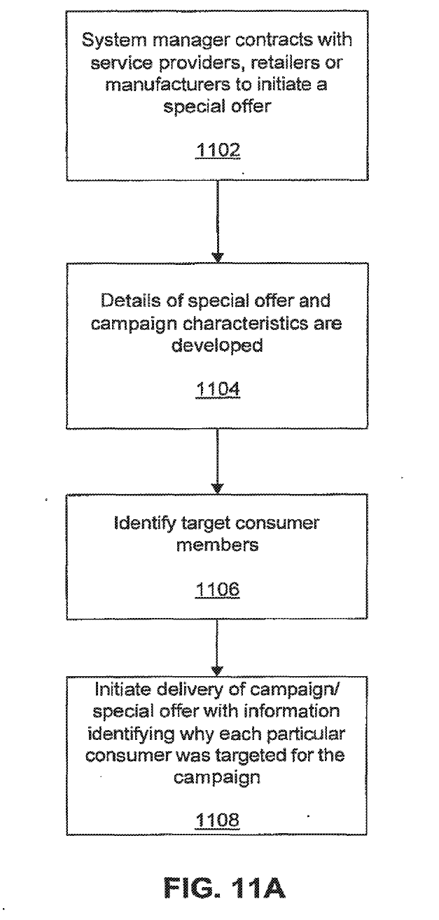

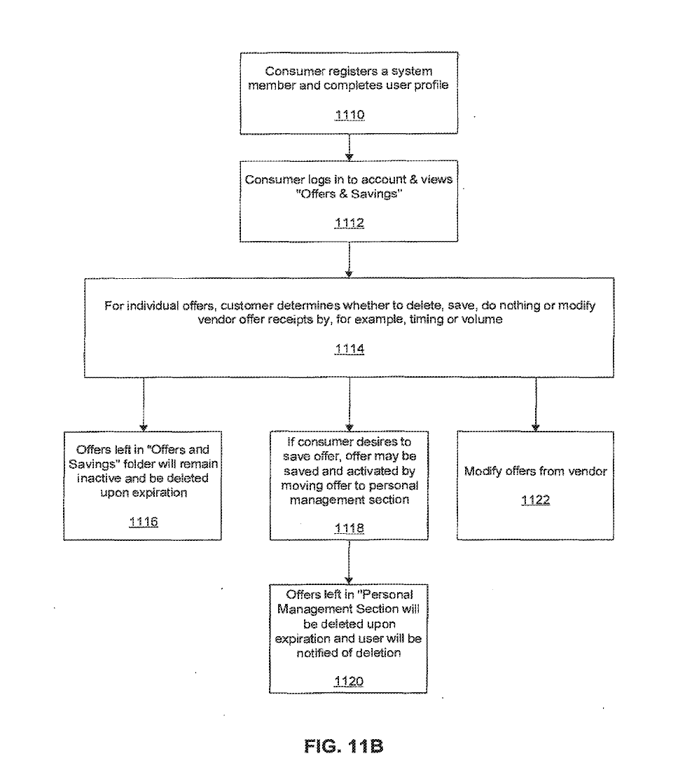

FIG. 11A is an example of a flow diagram illustrating the delivery of special offers and savings to target consumer for access and use by the consumer. As illustrated in FIG. 1, in order to receive special offers and savings for consumer system members, the system 100 manager contracts with service provides, retailers and/or manufacturers for the development of special offers to be distributed to target consumers, as illustrated in step 1102. Once the offer details are established and the characteristics of the campaign are identified, at step 1104, the system will, based upon the offer details and campaign characteristics, identify the consumer member to be targeted with the special offer, at step 1106. Finally, at step 1108 the system manager will send the special offer to the targeted consumers, which will be accessible by the consumers via their personal consumer system account. In this example, data will be sent with each special offer identifying why each particular consumer receiving an offer was targeted for the campaign.

Campaigns may be characterized by, for example, expiration dates, co-branding/short message service campaigns, offers searchable by non-target consumers, offers transferable among consumer members, on-line vs. off-line redemption, to name a few. To identify which consumer should be targeted for a particular offer or part of a campaign, targeting methods may include demographic, geographic, profile preferences/psychographics, recent purchases/uses, gift card/store credit ownership, loyalty program memberships, event calendar, travel calendar, word of mouth/previous campaign participation. Those skilled in the art will recognize that other targeting methods may be utilized and the targeting methods are not limited to those recited above and other campaign characterization categories may be utilized, along with the offer details, to help identify the target consumers.

FIG. 11B is an example of a flow diagram illustrating the consumer receipt and processing of special offers and saving. To be eligible to receive special offers and savings, a consumer must first become a registered system user. To receive targeted offers, the consumer must also complete a user profile. To view a consumer's offers and savings, a consumer would, after becoming a registered user, at step 1106, log onto the consumer's account and select the “View Offers and Savings” option in the features section 1004 of the example illustrated in FIG. 10. Upon selection of this tab, the consumer will be able to view the offers that were targeted specifically to him or her and also view the reasons for receipt of a particular offer. As illustrated in FIG. 10, accompanying each offer is identifying information that allows the consumer to determine why he or she received a particular offer.

For example, as illustrated in FIG. 10, in connection with each line-item offer, the consumer is provided with information that identifies why the consumer was selected to receive this offer. In this example, this identifying information is provided in the form of colored boxes containing different indicia. Each box represents a different targeting method that was used identify the consumer as a target recipient for the particular campaign offer. Users may be provided with a key to assist in identifying the different targeting methods. As previously discussed, these targeting methods, may include, but are not limited to, demographic, geographic, profile preferences/psychographics, recent purchases/uses, gift card/store credit ownership, loyalty program memberships, event calendar, travel calendar, word of mouth/previous campaign participation. As illustrated in FIG. 10, the user interface may also allow users to roll over the boxes representing the different target information. When the user rolls over the boxes, a text bubble or other signifier may appear that provides the consumer with detailed information regarding why a particular target box appears. Optionally, relevant sections in a consumer's personal management section may be highlighted to the extent that it corresponds to reasons detailed in a particular target box. For example, if the reason for receiving an offer was based upon a consumer being a loyalty program member, the loyalty program membership may be highlighted in the consumer's personal management section when the he views the target reason as being a loyalty member (as illustrated in FIG. 10).

After viewing a particular offer's details or detail summary, at step 1114 of FIG. 11B, a consumer may decide whether to delete or activate a particular offer or just do nothing. Optionally, a consumer may be provided with the option to provide feedback to a particular vendor regarding the offer, seek an increased or decreased volume of offers from a particular vendor or request the receipt of no offers from a particular vendor for a given time period.

A consumer may have the option of immediately deleting unwanted offers from their offer list. If, however, a consumer decides to do nothing with a particular offer, in the illustrated example, the offer will be deleted from the user's offer listing upon expiration of the offer, without notice to the consumer, step 1116.

At step 1118, if a consumer is interested in possibly using a particular offer, the consumer may activate the offer by moving the offer to the personal management section 1006 of the consumer's account. Once moved, the offer will appear in the personal management section 1006 under a tab of activated offers, which in the illustrated example is titled “My Special Offers.” In the illustrated example, at step 1120, once an offer expires, it will be removed from the consumer's personal management section 1006; however, the consumer will be notified of its expiration and deletion since special interest was shown in the particular offer.

Optionally, the system 100 may also allow a consumer to modify how he or she is targeted by a particular vendor, step 1122. In this regard, the vendor may be provided with a mechanism for sending feedback directly to a particular vendor. Furthermore, the consumer may seek more or less offers from a particular vendor, may seek offers of a particular type or category, or may seek to permanently or temporarily suspend the receipt of offers from a particular vendor.

Additionally, the system may be capable of gathering analytics and statistical data about the campaign performance and may provide such information to participating service providers, retailers and manufacturers.

B. Gift Card Purchase Feature

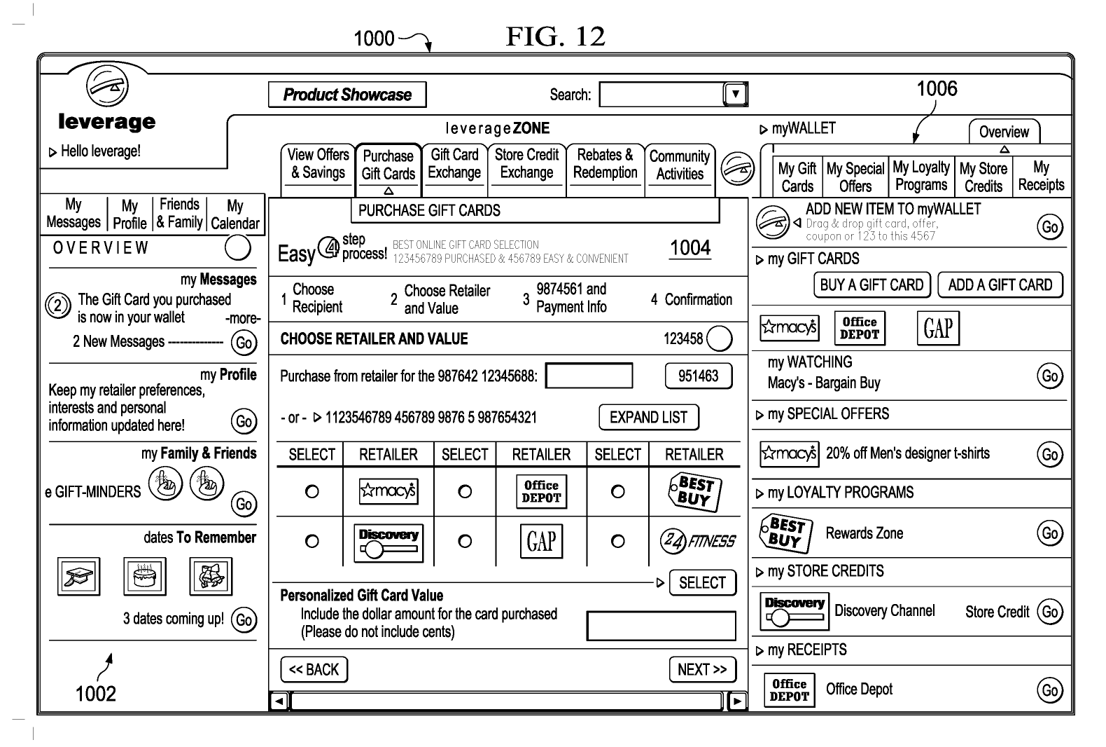

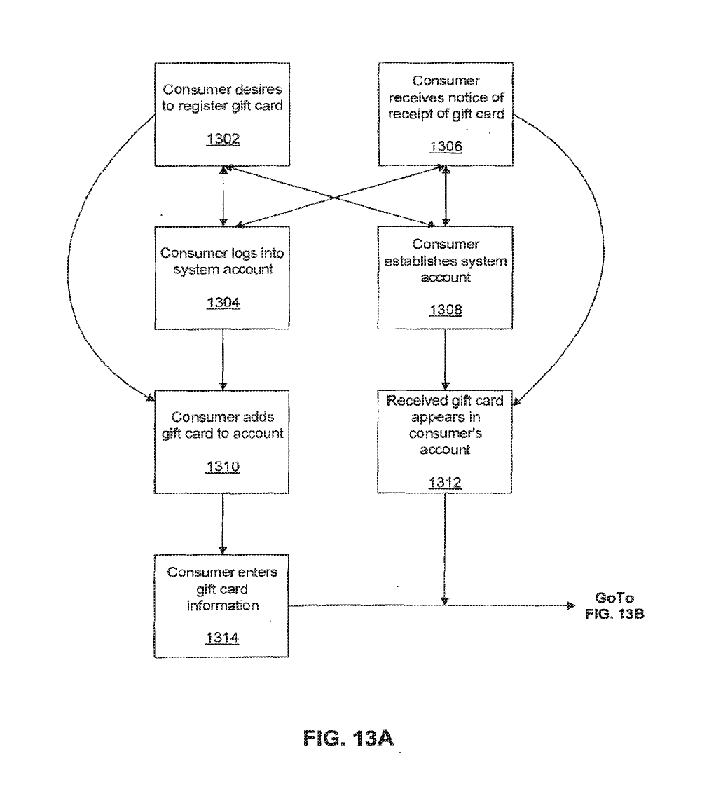

FIG. 12 is an example of a user interface that may be implemented for use by a consumer for the purchase of gift cards. In the example illustrated in FIG. 12, a consumer is provide with an option under the tab “Purchase Gift Card” in the features section 1004 of the consumer interface 1000. Using this function, a consumer is able to select or designate a gift card recipient. The consumer is then able to select the retailer from which to purchase the gift card and designate the gift card amount. The consumer may select multiple retailers and designate different amounts for each retailer. Recipient and payment information are provided to complete the purchase. In this example, a confirmation of the purchase is then provided to the provider.

Once the gift card purchase is complete, the consumer may receive either individual retailer gift cards or one universal transaction card configured for use as a gift card for the multiple retailers designated. The consumer may also have the universal transaction card sent to anyone designated by the consumer to receive the card as a gift.

C. Gift Card Registration Feature

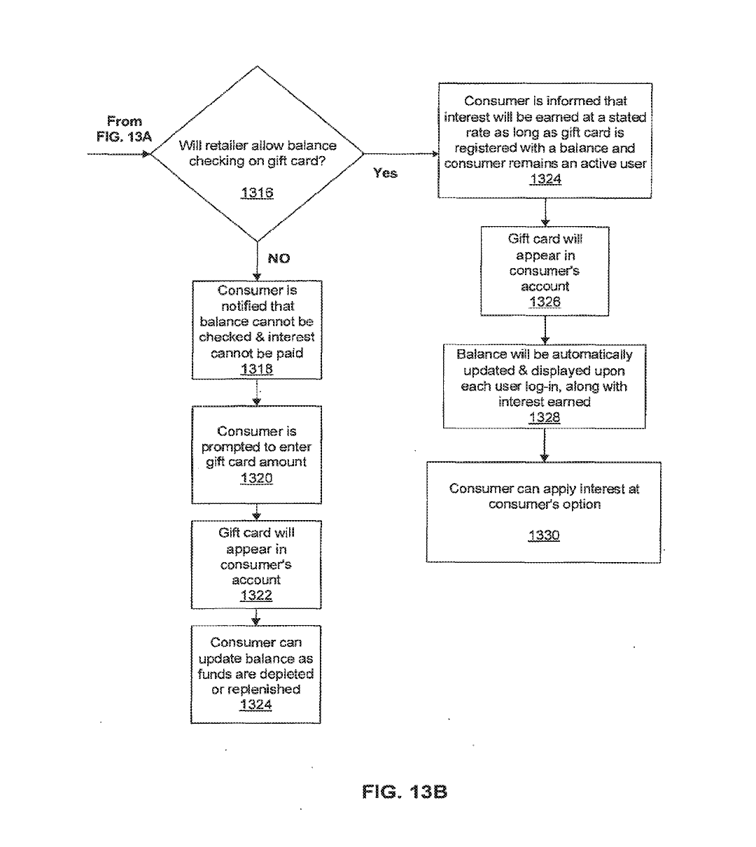

Also, as illustrated in the example shown in FIG. 12, a consumer is provided with an option under the tab “My Gift Cards” to register the consumer's gift cards, or to purchase a gift card utilizing the process described in FIG. 12 above. Once gift cards are registered in the system as associated with a particular consumer account, as explained further below in connection with FIGS. 13A & 13B, the gift cards will appear in the consumer system account. In this illustrated example, the gift cards appear in the personal management section 1006 of the consumer interface 1000 under the tab “My Gift Cards.”

FIG. 13A is an example of flow diagram illustrating the receipt, purchase and/or registration of a gift card by a consumer. As shown in FIG. 13A, the registration of a gift card with a consumer's account can be initiated in several ways. For example, the process can start with the consumer's desire to register a gift card 1302, in which the consumer can log onto his/her account, step 1304, to commence the registration process. Alternatively, if the consumer does not have an account, the consumer may first be required to establish a system account, step 1308.

In the illustrated example, once the account is established, a consumer may enter gift card information into the consumer's personal management section 1006. In this regard, the consumer will select an add gift card option in the consumer account. The system will then prompt the consumer to enter gift card information, such as vender information and card number, among other data, step 1314.

Additionally, someone may purchase a gift card for a consumer. If the consumer does not have an account with the system, the consumer may be notified by email, text message, mail or other notification method of the receipt of the gift card. This may then prompt the consumer to establish an account 1308, log on the system 1302, and use and or register the gift card 1302. Likewise, existing consumer account holders may receive notice of a gift card upon logging into their account by the gift card appearing in the consumer personal account, with notice to the consumer of the receipt of the gift, step 1312.

Whether a gift card is registered by gift or manually entered into the system 100 associated with a consumer account, in one example of an implementation, the system 100 may determine whether a particular gift card is eligible to bear interest. FIG. 13B is an example of a flow diagram illustrating an example of an interest bearing gift card implementation.

As illustrated in FIG. 13B, the system 100 will check if the vendor, i.e., service provider, retailer or manufacturer, will allow the system 100 to verify the balance on a gift card, step 1316. If the system cannot verify the balance on the gift card through the vendor, the system 100 will notify the user that the gift card is not an interest bearing card, step 1318. The consumer will then be prompted to enter the gift card amount, step 1320. The gift card will then appear in the consumer's account, step 1322 and the consumer will be required to update the balance of the funds as they are depleted or replenished, step 1324.

If, however, the system can verify the balance on a gift card, the system 100 can allow the accrual of interest for that gift card and will notify the consumer that the gift card is an interest bearing card so long as it carries a balance and the consumer remains an active system account holder, step 1324. The system will also notify the consumer of the interest rate. The gift card will then appear in the consumer's account, step 1326 and the system will automatically update the balance of the funds associated with the card upon each user login, step 1328. The balance information shall also include the accrued interest amount. Optionally, the system may allow the consumer different options on how to apply the interest. From these options, the consumer may then elect how to apply the interest, step 1330. For example, the interest may be added to the gift card, may be cashed out in the form of a check or funds transfer, may be moved to a system account for future purchases, or may be given to a designated charitable organization.

D. Gift Card Exchange Feature

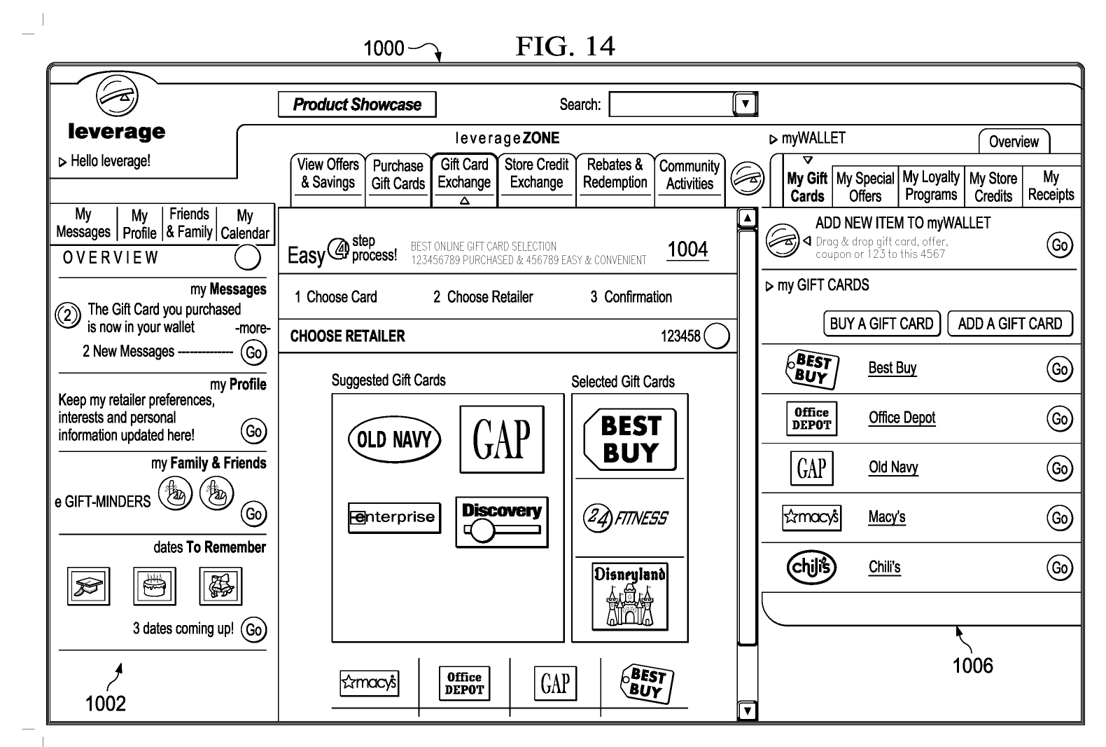

FIG. 14 is an example of a user interface that may be implemented to display a gift card exchange system and gift card balance check interface. As illustrated in FIG. 14, the system may include an option to allow a consumer to exchange or trade gift cards with other consumer system users. In the illustrated example, this function is available to a consumer under the “Gift Card Exchange” tab of the feature section 1004 of the consumer interface 1000. FIG. 14 further illustrates, under the “My Gift Card” tab of the personal management section 1006 of the consumer interface 1000 the system's ability to display registered consumer gift cards and the account balances of each card. As explained above in connection with FIGS. 12 & 13, such information may be obtained automatically by the system from the vendor or may be manually input into the consumer's account.

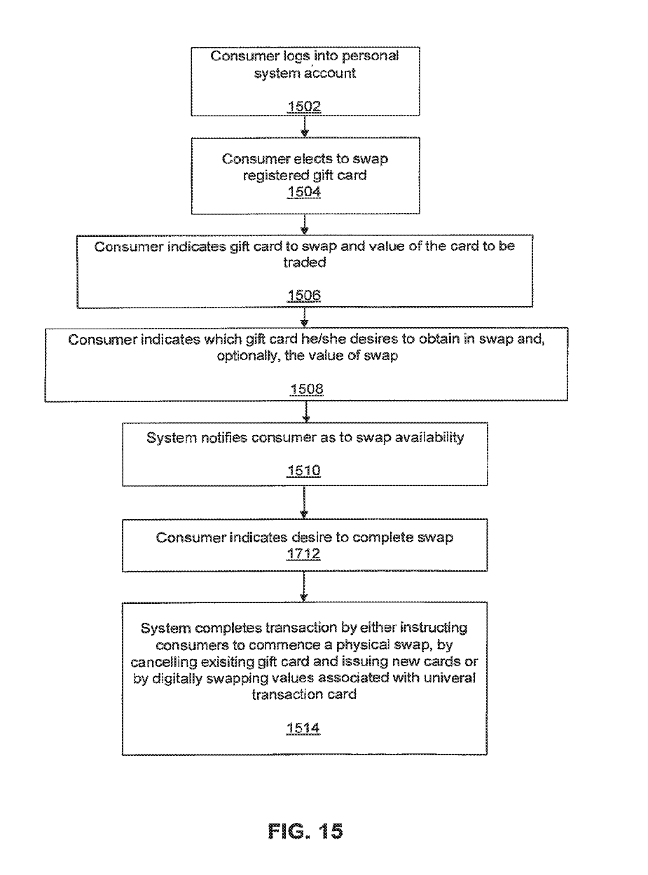

FIG. 15 is a flow diagram illustrating an example of the operation of one implementation of a gift card exchange program. As illustrated, to initiate a gift card exchange, a consumer first logs into their personal system account, step 1502. As shown in FIG. 14, this function may be made available to consumers via the feature section 1006 of the consumer interface 1000, accessible under a tab marked “Gift Card Exchange.” In this example, the consumer elects to trade registered gifts cards, as described in connection with FIGS. 12 & 13 above, step 1504, by selecting the gift cards to swap and indicating the value of the card to be swapped. When cards may be digitally swapped, via for example a universal transaction card, or gift cards may be cancelled and replaced with one or more new cards, partial gift card values may be exchanged. However, when the system 100 only provides for cards to be physically exchanged between consumer, gift cards must be swapped at full card value. The system 100 can be designed to alert the consumer when such limitations exist and prevent the exchange of partial value gift cards.

Once the consumer indicates which gift card he/she desires to trade and the value of the trade, the consumer must then indicate which gift card he/she desires to acquire in the trade and the value of the trade. Step 1508. For example, the trade may be a dollar for dollar trade, or, optionally, a consumer may offer a higher or lesser value trade for another gift card, i.e., $1.50 of the consumer card for a $1.00 on the trade. When electing which gift cards the consumer desires to acquire, the system 100 may seek a first choice trade and one or more alternative trade options.

Next, the system 100 will then determine if the trade can be immediately completed and if so, with which trade choice, e.g., the first trade choice or an alternative trade, step 1510. If no trade can be immediately completed, the system 100 may then give the user the option to cancel the trade or leave it pending until the desired trade can be completed. If the trade can be immediately completed, the system 100 will present the user with his trade options. The system will then give the user the option to complete the transaction, cancel the transaction or keep the transaction pending until another trade option becomes available. For example, if the first trade option is not available, but an alternative trade option is offered. The system 100 may allow the consumer to keep the trade pending until the first option becomes available for trade.

If the consumer indicates that he desires to complete a swap, step 1512, the system will then determine how best to complete the transaction and instruct the consumer accordingly, step 1514. For example, the system may complete the transaction by either instructing consumers to commence a physical swap, by canceling existing gift cards and issuing new gift cards or by digitally swapping vendors and associated values. A physical swap may occur through the system manager or may occur directly between the trading consumers.

When a digital swap is available, the system 100 will transfer the values associated with the vendor gift cards between the trading consumer accounts. The new gift cards and values will post on the respective consumer accounts and will be accessible via a universal transaction card or vendor gift card linked to the system 100 accessible via the consumer's account.

E. Loyalty Programs Management Feature

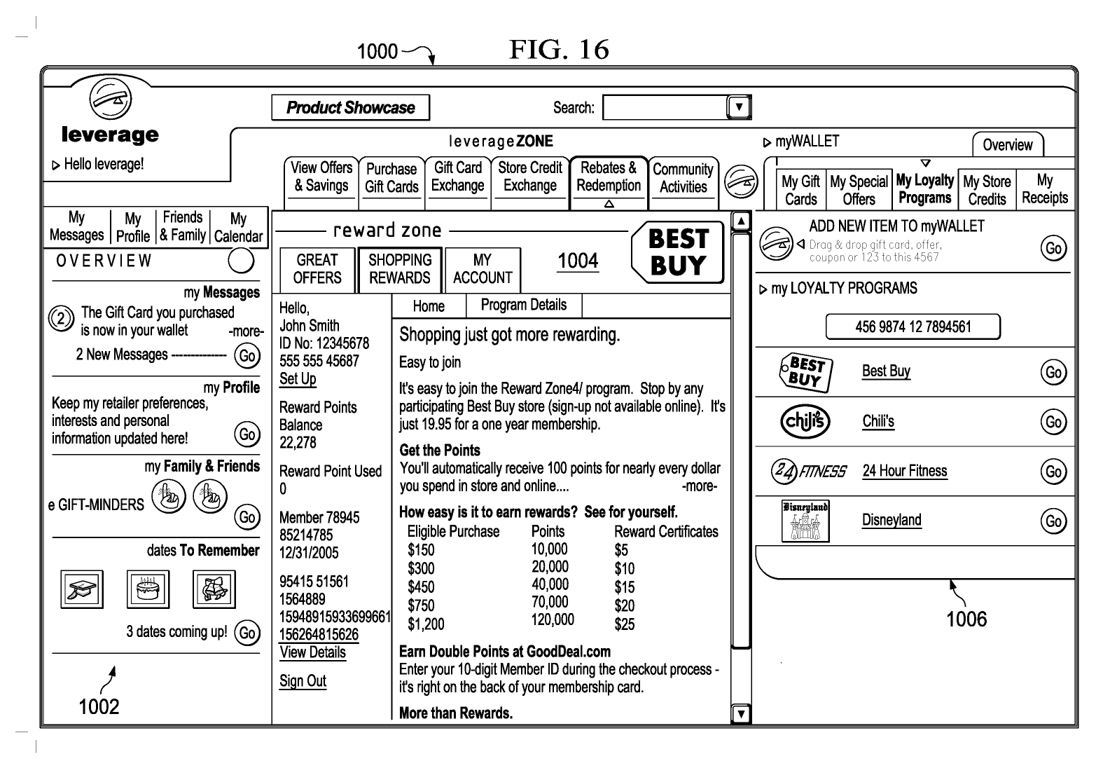

FIG. 16 is an example of a user interface that may be implemented to display various loyalty programs in which a consumer is participating and itemized details of a select loyalty program. In the illustrated example, a consumer may join or register various vendor loyalty programs. Such membership in the loyalty programs may be displayed in the consumer personal management section 1006 under the “My Loyalty Programs” tab. Upon selection, detailed information regarding a loyalty program and rewards earned by participating in such program can be displayed in the features section 1004 of the consumer interface 1000. Participation rewards and information for a particular loyalty program may be displayed by communication directly to the vendor's system to retrieve or link to the relevant data. Optionally, the system 100 may retrieve and parse the information to provide the information to the consumer in a modified format than the information format offered by the vendor.

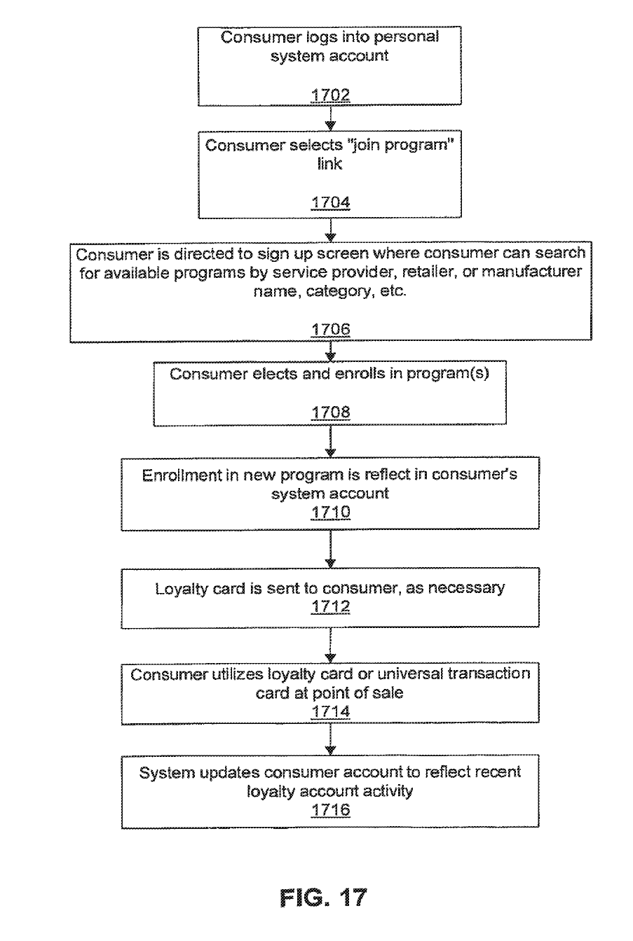

FIG. 17 is an example of a flow diagram illustrating consumer enrollment in a loyalty program and the update of information related to the loyalty program. While the system 100 may be designed to allow a consumer to manually enter and manually or automatically track loyalty information, as will be further described below, the system 100 may also allow a consumer to enroll in a loyalty program via the consumer interface 1000 and automatically track the loyalty program rewards for each loyalty program. Once a consumer is logged onto his personal system account 1702, the consumer may elect to join a loyalty program. As illustrated in FIG. 16, an election may be made on the consumer interface 1000 that permits the consumer to join select loyalty programs. In the illustrated example, this election is available under the “My Loyalty Programs” tab in the personal management section 1006 of the consumer interface 1000. To add an additional program, the consumer would select the “join new program” option on the screen, 1704.

Once the consumer elects to join a new program, the system would then direct the user to the sign-up screen (not shown) where the consumer may search for available on-line loyalty programs by vendor name and or category, such as electronics, step 1706. The consumer would then elect which program(s) to join and complete the necessary enrollment information form to become a loyalty member, step 1708. Enrollment in the new program would then reflect in the system account, for example under the “My Loyalty Programs” tab in the personal management section 1006 of the consumer interface 1000, step 1710. The system manager may then send an associated loyalty card to the consumer, if required by the vendor, step 1712, or if the consumer has a universal transaction card for the system 100, that identified account will automatically begin to track loyalty transactions. In either case, the consumer may be required to use the loyalty card or the universal transaction card to track consumer transactions at point of sale and receive loyalty rewards and/or benefits, step 1714. Whenever a transaction is completed using a loyalty card or universal transaction card applicable to a loyalty program, the system 100 can then update the individual consumer's account to reflect recent loyalty account activity, step 1716.

Optionally, the system 100 may receive manual input of loyalty information and based upon the input of information, download associated loyalty information or provide an automatic link, for example, through a web browser, to the consumer's loyalty information on the vendors' website, as illustrated in FIG. 16.

F. Event and Travel Offer and Savings Feature

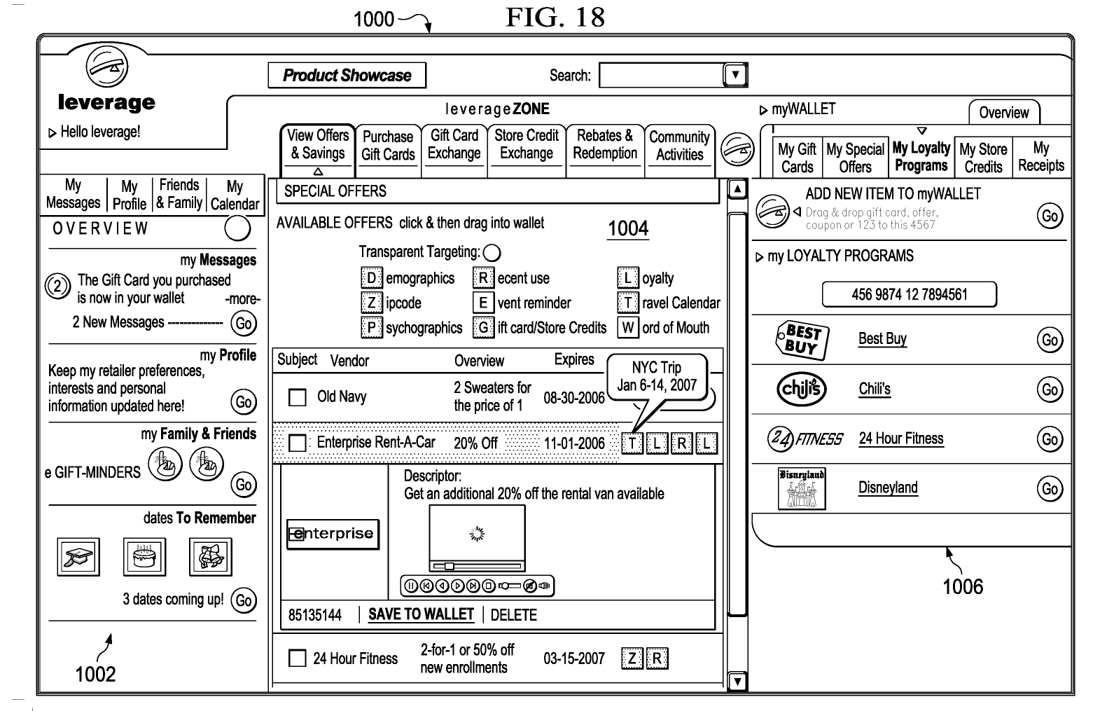

FIG. 18 is an example of a user interface that may be implemented to display a targeted offer sent to the user in response to the user completing a travel calendar. In the illustrated example, the offer from Enterprise, displayed in the consumer's offer listing, indicates that is was send to the consumer using a travel calendar targeting method, among other methods. This is evident by the “T” in the box displayed at the end of the first line of the offer. When the user scrolls over the target box indicating the target method was the travel calendar, the consumer reveals that the offer was sent to him/her in part because he/she had indicated that they were going on a trip to New York, Jan. 8-14, 2007. Accordingly, in this example, this offer was sent in response to information that the consumer placed in his/her personal profile section 1002 regarding an upcoming trip to New York. As will be further described below, similar offers can be targeted to specific consumer based upon event information identified in a consumer personal profile, as well as travel or trip information.

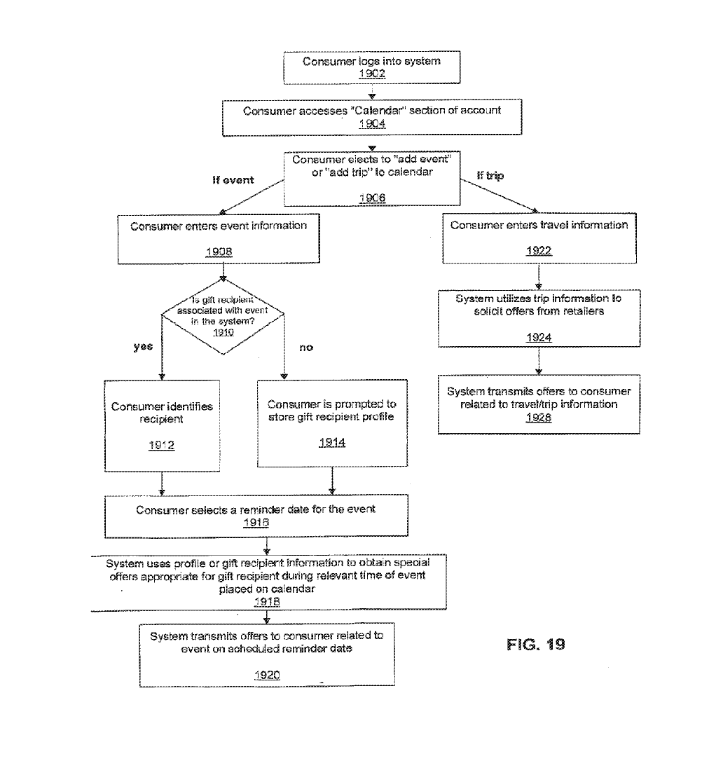

FIG. 19 is an example of a flow diagram illustrating the delivery of special offers and savings to target consumer in response to the completion of an event or travel calendar. For a consumer to enter event or travel information, the consumer must first be logged into the system 100, step 1902. Once logged on, the consumer is then able to access a “Calendar” section of the consumer account, which may be located in the personal profile section 1002 of the consumer interface 1000. This section may also be combined with or part of a “My Dates to Remember” section, as illustrated in the example in FIG. 18.

Under the calendar section the consumer will be provided with various options, which may include, but not be limited to, entering event and trip information. The consumer can then elect to enter either type of information into the consumer's personal profile, step 1906. If the consumer enters an event into his/her profile, for example, a wedding or an individual's birthday, step 1908, the system 100 will then prompt the consumer to associate a gift recipient with the event, 1910. If the recipient's profile is already in the system 100, the system 100 will then prompt the consumer to identify the recipient, step 1912. If the consumer is not in the system 100, the system 100 will then prompt the consumer to enter the recipient's profile information, step 1914. Optionally, the system 100 may also prompt the consumer to select a reminder date for the event, 1918.

Using the event information, user profile and gift recipient information, the system 100 can then work with vendors to obtain appropriate offers for gift recipients prior to the event placed on the calendar, step 1918. Such offers can then be transmitted to the consumer, which will then appear as part of the consumer's offers and will reference the offer receipt as associated with the particular event.

Alternatively, in the case of a trip, the consumer may enter travel information into the consumer's user profiles, such as dates of travel, travel method, destinations, mode of transportation, point of interest, etc. Similar to the event calendar, the system can then use this information to solicit offers from vendors that pertain to the trip dates, destinations and travel plans, step 1924. Such offers can then be transmitted to the consumer, which will then appear as part of the consumer's offer listing and will reference the offer receipt as associated with the particular trip, as illustrated in FIG. 18, which shows a rental car offer applicable for the dates of travel.

G. Short Message Services Offer and Savings Feature

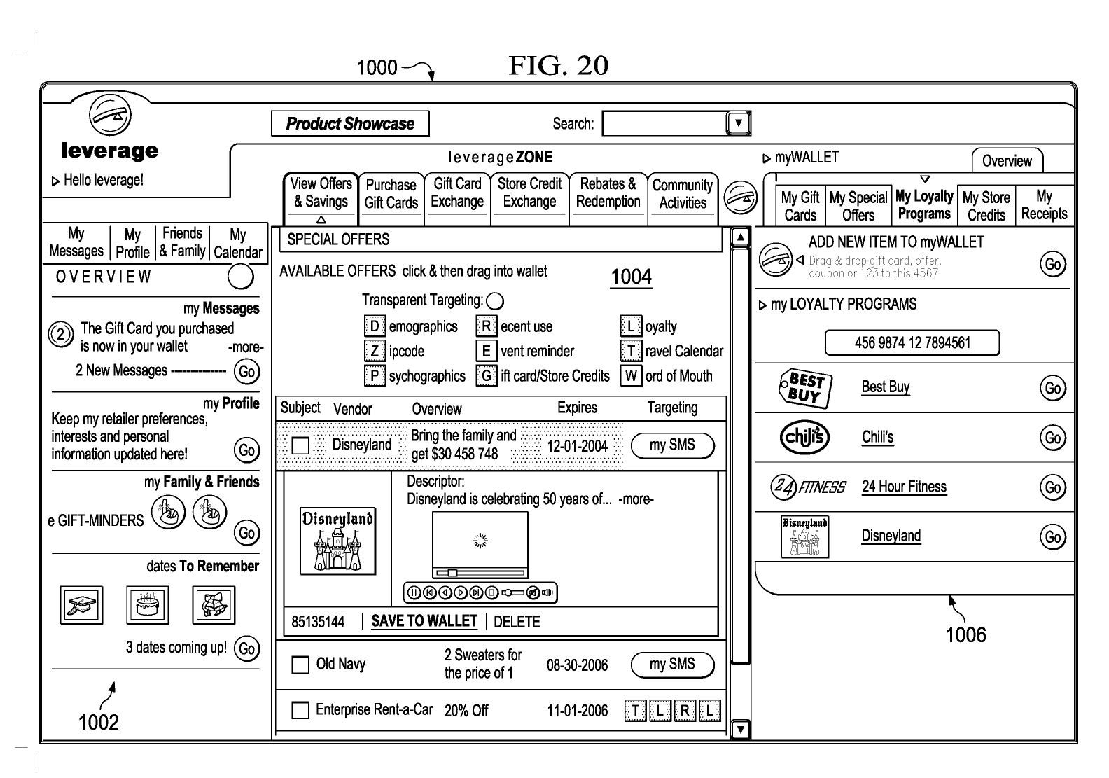

FIG. 20 is an example of a user interface that may be implemented for use by a consumer and which provides a consumer with the ability to have targeted offers sent to the consumer's personal system account via a short message service text message. As illustrated in FIG. 20, two SMS type offers are listed as an item in the in the offers and savings section of the feature section 1004 of the consumer interface 1000. This offer type represents an offer that is sent to a consumer's account in response to a short message service (“SMS”) message sent by the consumer requesting that the offer be sent to his or her personal system account.

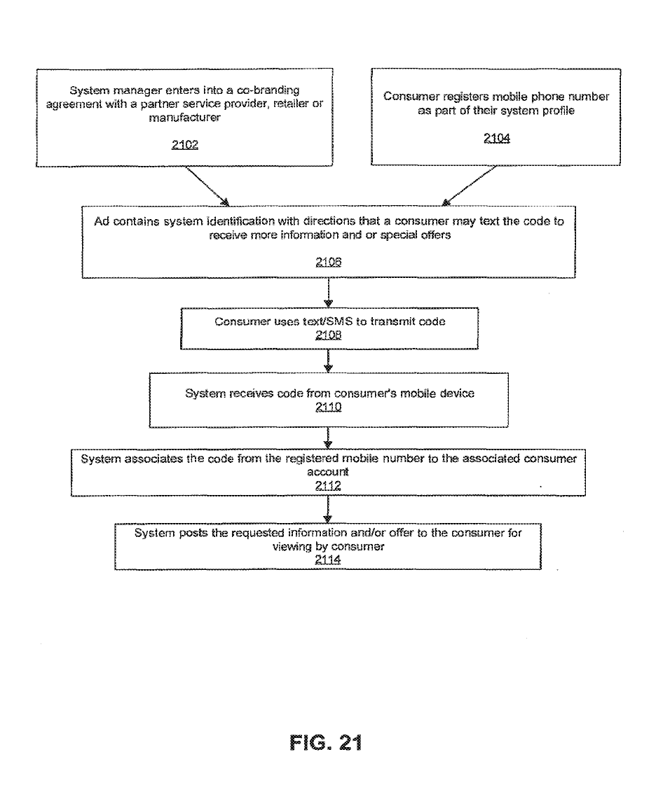

FIG. 21 is an example of a flow diagram illustrating the delivery of special offers and savings to consumers upon the receipt of a short message service text message. As illustrated in FIG. 21, to receive offers via a text message or SMS message request, both the consumer and the retailer (i.e., service provider, retailer and/or manufacturer) must allow for such a transaction to occur. At step 2102 of FIG. 21, the retailer must enter into a co-branding or services agreement with the system 100 manager to offer a text messaging or SMS type campaign. Further, at step 2104, the consumer desiring to use such service must register his/her mobile phone number as part of their personal system profile.

In the illustrated example, when an advertisement is run, it would contain a system logo/identifier and directions that instruct consumer as to how to text a code to the system to receive more information about the advertisement and/or a special offer shown in the advertisement (step 2106). Such advertisements may include print advertisements, such as newspaper, magazine, email, mailing, outdoor advertisement, etc., or may be a radio, television or new media advertisement, among other types. Consumers can then text or SMS to transmit the code to the system manager at step 2108. The system will then receive the code from the user's mobile device at step 2110, match the code associated with the registered mobile number to a consumer account at step 2112 and post the requested information or offer to the consumer's account, step 2114. As illustrated in FIG. 20, the requested information or offer may be posted in the consumer's offer listing. Similar to other offers, as described in connection with FIGS. 10 & 11, the targeting legends/boxes associated with an offer received from a consumer text request or SMS may indicate as such. In this example, the offer is identified as a “My SMS” type offer. The consumer may then delete, save and activate, or do nothing with the offer, among other things, as further discussed above in connection with FIGS. 10 & 11. Other implementations of this feature will also be developed that capture information and offers into a consumers account but allow for this capture to be done with technologies different from using cell phone SMS. One other implementation is that with upcoming generations of television equipment and set top boxes that specific button(s) could be incorporated directly into a remote control device which can capture information into a consumer's account at the push of a button from various ads and commercials.

H. Digital Receipts Feature

As illustrated in FIGS. 10, 12, 14, 16, 18 and 20, the system 100 may include a feature, which in this example, is located in the personal management section 1006 of the consumer interface 1000, that allows the consumer to receive digital receipts detailing his/her purchase with participating service providers, retailers or manufacturers. In this regard, digital receipts itemizing consumer transactions with specific service providers, retails or manufacturers may be visible via a consumer's personal system account. Use of specific payment options, coupons, loyalty cards, universal transaction card, or other means for identifying a consumer may be utilized to trigger the transmission of a digital receipt to a consumer's account. Once received by the system, the consumer may search, sort, store, download or print received digital receipts and may even be able to import or copy the digital transaction data into a personal bookkeeping program.

I. Enhanced Rebate and Marketing Program Feature

As illustrated in FIGS. 10, 12, 14, 16, and 18-23, the system 100 may also include a feature, which in this example is located in the features section 1004 of the consumer interface 1000 that allows a consumer to locate, submit and/or track rebate redemption offers. In this regard, rebate searches can be performed by the system based on product purchases or specific rebate information. On-line or downloadable forms (for hand-written correspondence) can be provided for rebate program submission. Further, rebates may be submitted on-line using digital receipts or other exhibits. Optionally, rebates may be tracked on-line as well. Moreover, all the functionalities of the systems and methods previously described, e.g., in the context of the described “targeted marketing and consumer resource management,” “enterprise infrastructure,” “partner interfaces to the enterprise infrastructure,” “pos terminal interfaces,” “retail partner application architecture,” and “consumer front-end,” are applicable to and available via the following disclosed “enhanced rebate and marketing program.”

A. Automatic Enrollment

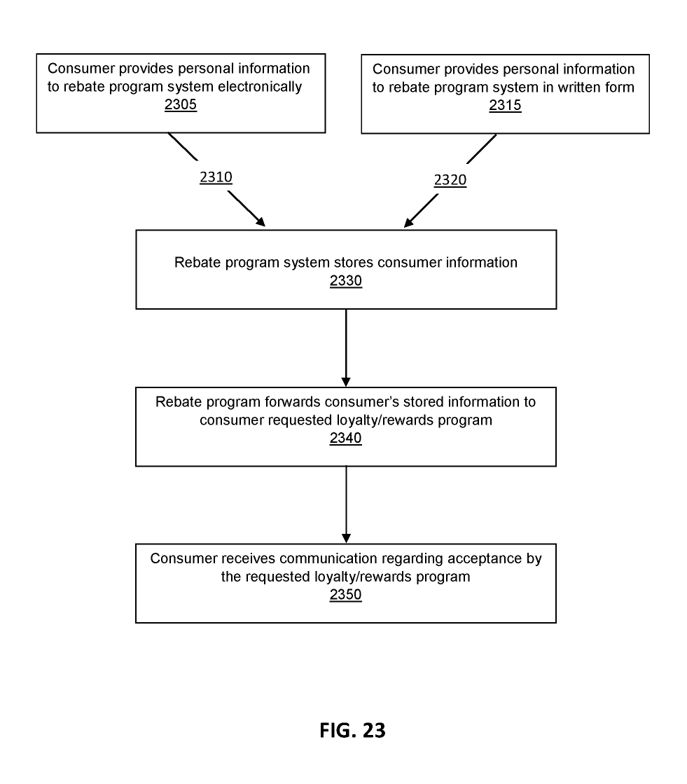

As shown in FIG. 23, when a consumer desires to participate in the disclosed enhanced rebate and marketing program, the consumer will be prompted to provide basic personal information to the system, e.g., the consumer can provide the information as part of the profile section 1002 of the consumer's personal account, as independently entered information into an interface 2305 which communicates with the enhanced rebate and marketing program directly 2310, or by providing the personal information in written form 2315 which is then digitally converted by a component of the enhanced rebate and marketing program system 2320. In particular, the consumer will be asked to provide basic profile information, including, but not limited to, demographic information, such as age, gender, zip code preference information regarding consumer likes and dislikes and information about friends and family for whom the consumer may purchase gifts or items.

The rebate program system stores the received consumer information in a database 2330. A consumer who is redeeming a rebate on-line using a computer, tablet, smartphone, smart TV or other device or by paper mail-in process can select to have the personal information they provide during the rebate validation process be automatically enrolled in a specified loyalty program. This convenience allows them to join a loyalty/reward program without re-entering their information after the rebate submission process is complete.

When the consumer completes the rebate process, the key fields of their personal information provided during the rebate redemption process that are required to sign up for a specified loyalty/rewards program are gathered together electronically and forwarded to a the specified loyalty/rewards sign up platform, database or to an enrollment process team for entry 2340.

When the sign up data for the loyalty/rewards program is accepted (or rejected) by the loyalty/rewards program, the consumer will receive communication from the loyalty/rewards program directly (or from rebate program) regarding the consumer's acceptance or rejkection into the loyalty/rewards program, just as they would if the consumer had signed up independently through a digital or paper submission processes directly to the loyalty/rewards program 2350.

This proprietary process requires technology that enables the ability to identify and pull key fields of information together and pass them as a single file. In the case where a consumer submits via paper mail-in submission, the information is electronically entered into a data collection engine that uses the same technology that identifies and pulls key fields of information together and passes them as a single file to the identified loyalty program.

B. Marketing Opt-In

A consumer who is redeeming a rebate(s) on-line using, e.g., a computer, tablet, smartphone, smart TV or other device or by paper mail-in process can select to receive marketing communication based on their interests and behaviors and other information specified during the opt-in process.

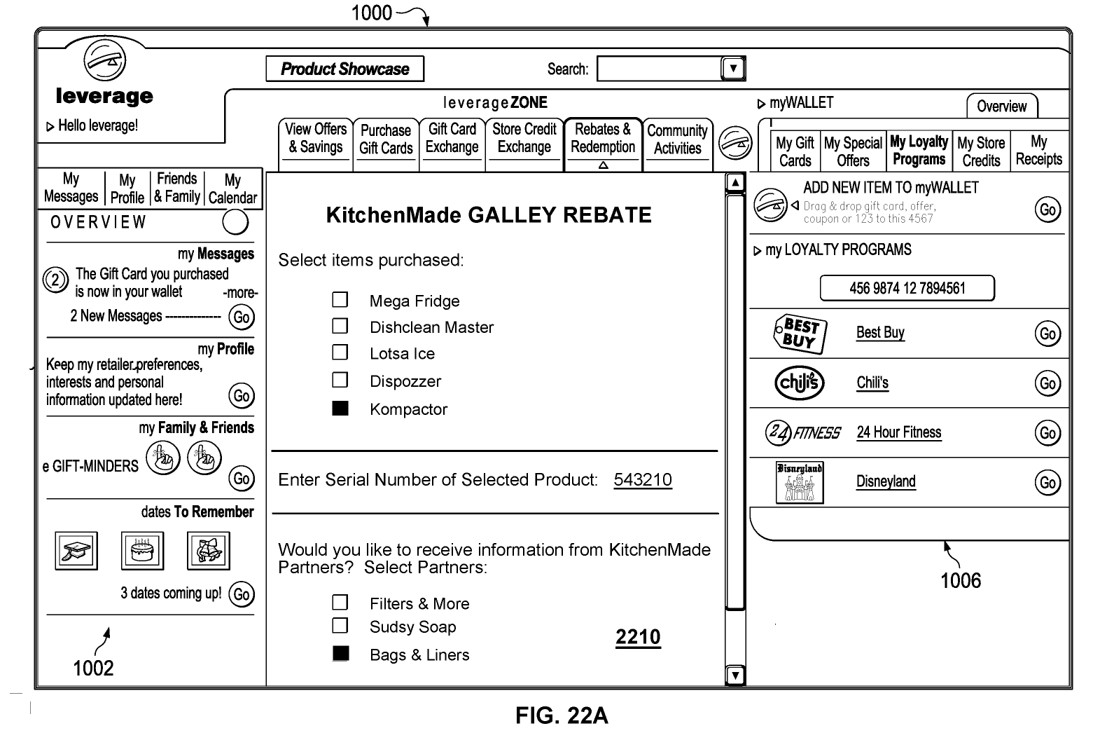

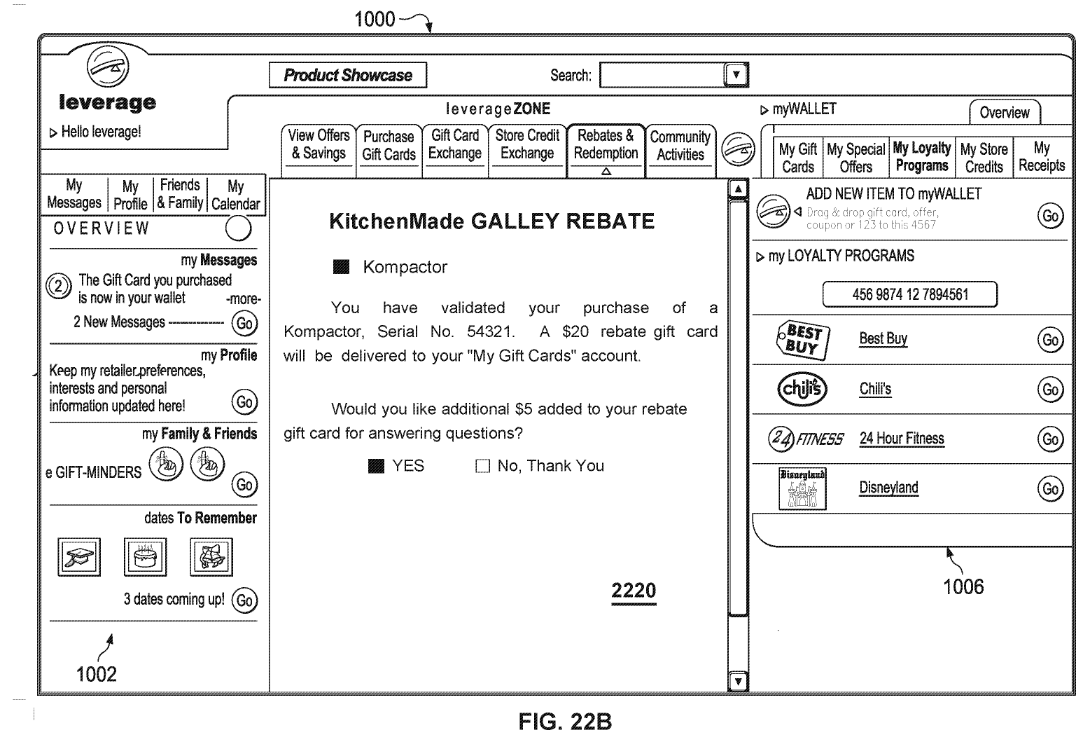

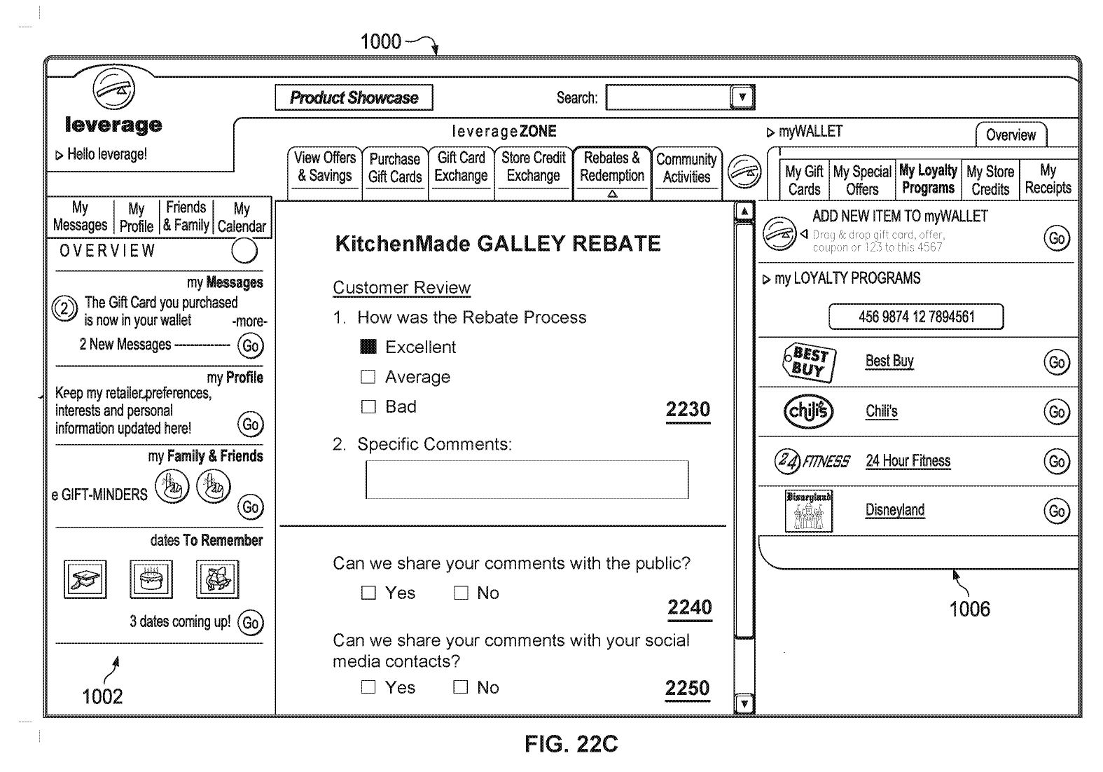

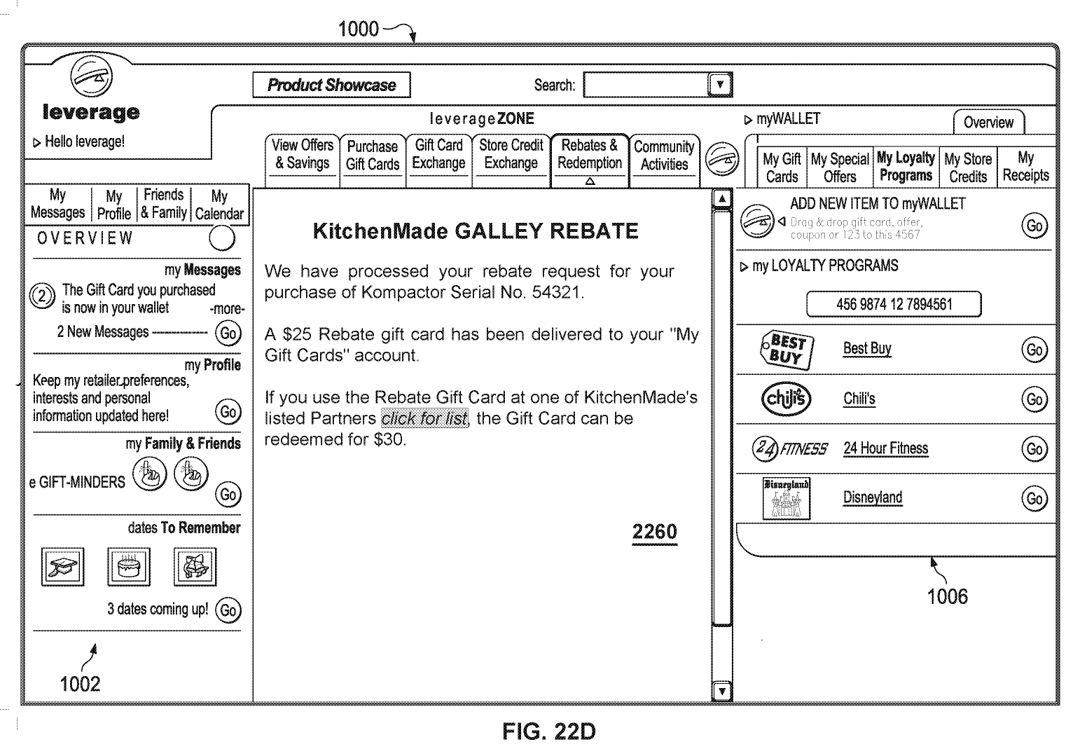

As shown in FIG. 22A, when the consumer completes the rebate application process 2210, key fields provided during the rebate application process which provide consumer shopping preference insights are collected together as an individual file and passed to a database of the enterprise infrastructure for future communications with the consumer, retail partners, prepaid card issuers, rebate program sponsors, and/or customer relationship management campaign providers.

The consumer who chooses to receive future marketing communication will receive marketing messages just as they would if the consumer had signed up independently through a digital or paper submission processes.

C. Targeted Rebate Rewards

A consumer who is redeeming a rebate(s) on-line, e.g., using a computer, tablet, smartphone, smart TV or other device can receive personalized, dynamic reward choices that are determined by responses to questions asked and answered, in real-time, during the rebate process.

This targeted rebate rewards system comprises a questionnaire module that generates and presents queries to the consumer at anytime/anywhere in the rebate submission/redemption process prior to reward selection which then dynamically serves reward options based on the consumer response.

For example, as shown in FIG. 22B, when a promoted reward offer example is a $20 prepaid card after validating purchase. During the reward redemption process for the $20 prepaid rebate offer, questions about reward preference are included that serve reward selection options based on the consumer's responses 2220. Example Consumer Questions That Filter For Reward Choice: “Interested in earning an additional $5 on your reward? Yes or No?” “Interested in an iTunes gift card as your reward? Yes or No?” Depending on how the consumer answers these questions, a dynamic reward choice selection option appears in the rebate redemption process for the consumer to choose their reward.

In an embodiment three reward choices appear, but the reward choices could be much greater in number. Example reward choice: $20 prepaid reward, $25 gift card that can only be used at one retailer or $20 iTunes e-card. The consumer chooses the reward they desire and the reward is generated and forwarded to the consumer's account (which is accessible via the disclosed interface system).

As shown in FIG. 22C, in another embodiment, the system may query the consumer 2230: How was our service? 1) Excellent, 2) Average, 3) Bad. If Average was chosen, the system could automatically schedule a follow-up contact with the consumer to improve by a representative of, e.g., the rebate program sponsor, prepaid card issuer, merchant, transaction processor, or combinations thereof If the consumer approves posting review results could appear on websites and in communication related to the specific product or service. In a further embodiment, the system may ask the consumer if the consumer's responses may be shared publically 2240. If the consumer agrees that any responses provided may be publically shared, the system can query the consumer as to which social media platforms (and/or other publication systems) may be used to disseminate the consumer's responses and feedback (as well as if the system may utilize the consumer's social media contacts as recipients of the consumer's responses, comments, and/or feedback) 2250. The system can then offer the consumer (and/or the recipients of the consumer's responses, comments, and/or feedback) targeted offers, coupons, savings, advertisements, questionnaires or combinations thereof which relate to information pertaining to the consumer or recipients available to the system.

In another embodiment, the system may query the consumer with specific questions regarding the consumer's experience concerning the rebate program (or other system offerings) and provide the consumer with pre-set responses to said questions or an opportunity to submit consumer drafted responses. For example, the consumer, at any time during the rebate submission process, could be asked: Are you interested in receiving savings on coffee products? Yes or No? A yes answer could have the following outcomes: a reward option for coffee products could be offered in addition to the promoted reward; a savings offer for coffee products could be delivered at the completion of the rebate process; or a savings offer for coffee products could be delivered electronically or physically in future communications and engagements with the consumer, both through the rebate process or in general marketing communication. In an additional embodiment, the targeted rebate rewards system can determine, based on information stored in a database accessible by the targeted rebate rewards system, what types of products and/or services the consumer has requested rebate information or redemption concerning. For example, if the consumer is currently requesting a $5 rebate for a coffee purchase and the targeted rebate rewards determines that the consumer has previously submitted a rebate application for an energy efficient air filter, the system could direct advertisements, coupons, and or other offers to the consumer relating to a coffee-related product or service and/or an energy efficient air filter-related product or service. In an embodiment, the system could deliver a $5 prepaid stored-value card to the consumer (either an electronic stored-value card (which may be digitally conveyed) to the consumer's account or a physical card to an address provided by the consumer) to satisfy the rebate request and that prepaid stored value card could comprise a value added component communicating and/or providing the consumer a coupon, savings, or other incentive related to a coffee-related product or service and/or an energy efficient air filter-related product or service that can be received by the consumer when the $5 prepaid stored-value rebate card is used for a particularly designated purchase or other use.

D. Value Added Bonus

As discussed above, the enhanced rebate and marketing program can provide value added bonuses to the consumer's received rebate. For example, a consumer who is redeeming a rebate(s) on-line, e.g., using a computer, tablet, smartphone, smart TV or other device can select to receive a bonus that adds value to a prepaid stored value card the consumer will receive in response to the consumer's rebate request.

In an embodiment, for example, a consumer buys a $50 iTunes gift card and goes to a rebate site to redeem a $10 bonus e-code. A custom code worth $10 is forwarded to the consumer to place into their gift card account.

In another embodiment, a prepaid stored value card with a face value of $25 may be received by a consumer from the enhanced rebate and marketing program in response to a $25 rebate request, however the card may be activated by the enhanced rebate and marketing program for $30—the $25 rebate value plus an additional $5 added as an incentive to trade with the providing merchant, rebate program sponsor, prepaid card issuer, etc. Alternatively, rather than adding cash value to the card, the card may be encoded, in addition to the face value of the card, with a redemption coupon for a specific product or service. For example, a $25 gift card to a coffee house may have an electronic redemption coupon for a free shot of the consumer's syrup of choice to be added to any coffee purchased at the coffee house. The free shot of syrup may be redeemed in connection with redeeming a portion or all of the gift card amount or the free shot of syrup may be redeemed separately.

In another embodiment, as shown in FIG. 22D, the rebate recipient may be incentivized to redeem a rebate program prepaid stored value card by a merchant/vendor which is receiving the rebate program prepaid stored value card as part of a purchase transaction, by the merchant/vendor adding value in addition to the face value of the rebate prepaid stored value card at the time the consumer redeems the stored value card 2260. For example, a merchant could run a promotion in which it offers consumers an additional $5 in purchasing power when the consumer uses a particularly identified rebate prepaid stored value card for a purchase at one of the merchant's retail stores during a specified period of time.

Those skilled the in art will recognize that it is possible to design a consumer interface 1000 that has a very different look and feel from the example consumer interface illustrated above in connection with FIG. 10-23. According, the example of the consumer interface of FIGS. 10-12 is provided for illustrative purposes only and the disclosure should not be limited to the illustrated consumer interface 1000 design. Alternative consumer interface designs performing implementation of similar functionality should be considered within the scope of this disclosure.

As illustrated in FIGS. 1-23 above, the system 100 enables specialized target marketing across multiple channels, including, but not limited to, online, offline, direct marking, etc., and further enables the tracking of consumer spending across multiple channels, including, but not limited to, both on-line and offline purchases of brick and mortar retailers, as well as other on-line and off-line retailers. Accordingly, the system 100 is capable of target marketing to different retailers, service providers and manufacturer, through various channels, including both on-line and offline marketing and sales.

Additionally, while the system 100 may be implemented to allow consumers to initiate and track different retail transaction utilizing individual retailer offers, gift cards, coupon, store savings, etc. As discussed above, the system 100 may also be implemented with a universal transaction identifier associated with each consumer account that is capable of communicating with the system 100 such that specific vender information may be accessible utilizing the universal transaction identifier. Such information, when accessed, may then be applied to a consumer transaction with the associated vendor, through the use of the universal transaction identifier. By way of example, in one implementation, the universals transaction identifier, when used by a consumer, enables the point of sale vendor/retailer to identify the consumer, which allows access to the program, discount and monetary resources available to the consumer, such as gift cards, loyalty programs, saving, etc., as reflected in the system 100, that relate to the transaction as a whole or the items purchased during that transaction.

E. Instant Rebate Management Program

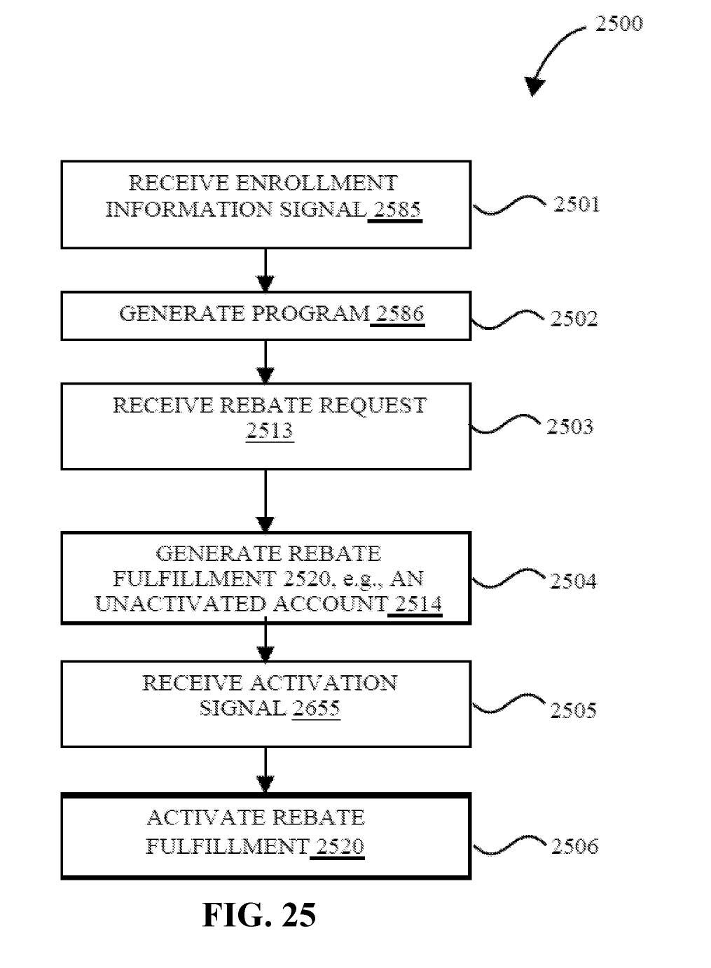

In an embodiment of the instant rebate management program, as shown in FIG. 25, a trade ally enrolls in the instant rebate management program (block 2501). The trade ally performs some activity/service for a client (e.g., installs an air conditioning unit or delivers furniture) (block 2502). Upon completion of the trade ally's activity/service, the trade ally submits a rebate request 2513 to the instant rebate management system 2400 (e.g., the enterprise infrastructure and system network of FIGS. 1 and 2), and upon verification by the instant rebate management system 2400 that the trade ally's activity qualifies for a rebate, the instant rebate management system 2400 generates a rebate fulfillment 2520 which may be associated with a rebate fulfillment value 2516 (block 2504). The trade ally receives the rebate fulfillment 2520. In an embodiment the rebate fulfillment may comprise an unactivated rebate fulfillment account 2514 and/or rebate fulfillment value 2516 (e.g., an unactivated prepaid stored value card) from the instant rebate management system 2400 (block 2505). In an embodiment, the unactivated rebate fulfillment account 2514 and/or rebate fulfillment value 2516 can be a physical prepaid stored value card that the trade ally provides to the client at the time of activity completion or a virtual prepaid stored value card that the trade ally delivers electronically to the client at the time of activity completion. The trade ally provides the unactivated rebate fulfillment account 2514 and/or rebate fulfillment value 2516 to the client and the client activates the unactivated rebate fulfillment account 2514 and/or rebate fulfillment value 2516, e.g., the client accesses the trade ally's website or a rebate fulfillment account processor/issuer (e.g., the instant rebate management system 2400) to activate the unactivated rebate fulfillment account 2514 and/or rebate fulfillment value 2516 for use (block 2506).

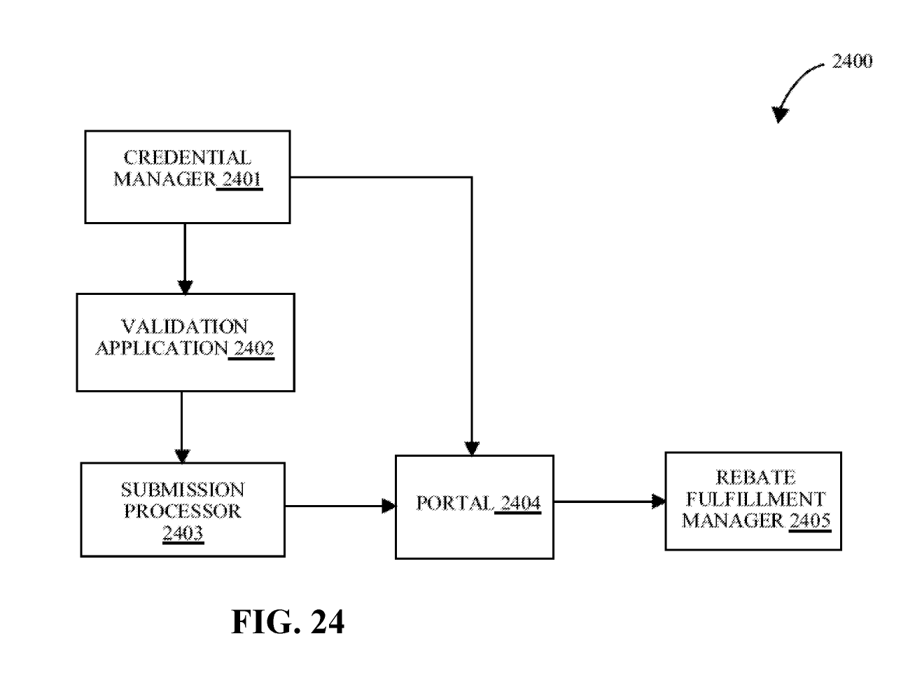

Referring to FIG. 24, an instant rebate management system 2400 comprises a credential manager 2401, a validation application 2402, a submission processor 2403, a portal 2404, and a rebate fulfillment value manager 2405.

The credential manager 2401 may be utilized to generate credentials to access other components of the rebate management system 2400. The credentials may be associated with one or more signals comprising information or instructions. The credentials may be associated with one or more programs, which may comprise one or more products.

The validation application 2402 receives input signals and associates them with credentials generated by the credential manager 2401. The input signals may associate products, product details, rebates, rebate recipients, and validations. The validation application 2402 determines the location coordinates for the input signals. In some embodiments, the rebate management system 2400 accesses a mobile device location (such as GPS) to determine the location coordinates.

The submission processor 2403 stores the associated signals and credentials. The stored signals or credentials may be further processed.

The portal 2404 may be used to access the credential manager 2401 or the submission processor 2403. An input signal may be received and compared to the credentials to determine whether access is granted.

The rebate fulfillment value manager 2405 may be utilized to associate input signals with a rebate fulfillment value 2516 and store the associations in a control memory structure. The rebate fulfillment value 2516 may comprise a prepaid stored value card (virtual, physical, or both), a coupon, a credit, a token, loyalty points, or any other accepted value.

The instant rebate management system 2400 performs a real-time validation and when valid, enables a rebate fulfillment value 2416 be linked to associated stored signals, such as a rebate submission. That same rebate fulfillment value 2416 (e.g., a stored value card) may then be activated by a customer via the portal 2404 and the rebate fulfillment value manager 2405.

Referring to FIG. 25, an activation method 2500 receives an enrollment information signal 2585 (block 2501). From the enrollment information signal 2585, a program 2586 is generated (block 2502). A rebate request 2513 is received (block 2503), where the rebate request 2513 may comprise inputs including product selection, product information, customer information, and verification information.

In response to the rebate request 2513, an unactivated rebate fulfillment account 2514 is generated (block 2504). The unactivated rebate fulfillment account 2514 may be associated with a rebate fulfillment value 2516. A rebate fulfillment data signal 2618 may be utilized to associate the unactivated rebate fulfillment account 2514 with a rebate fulfillment value 2516. An activation signal is received (block 2505) and the rebate fulfillment account is activated, i.e., the rebate fulfillment value 2516 may be accessed and/or used by an authorized user of the rebate fulfillment account, e.g., a consumer whose purchasing activities resulted in the receipt of the rebate/rebate fulfillment value (block 2506).

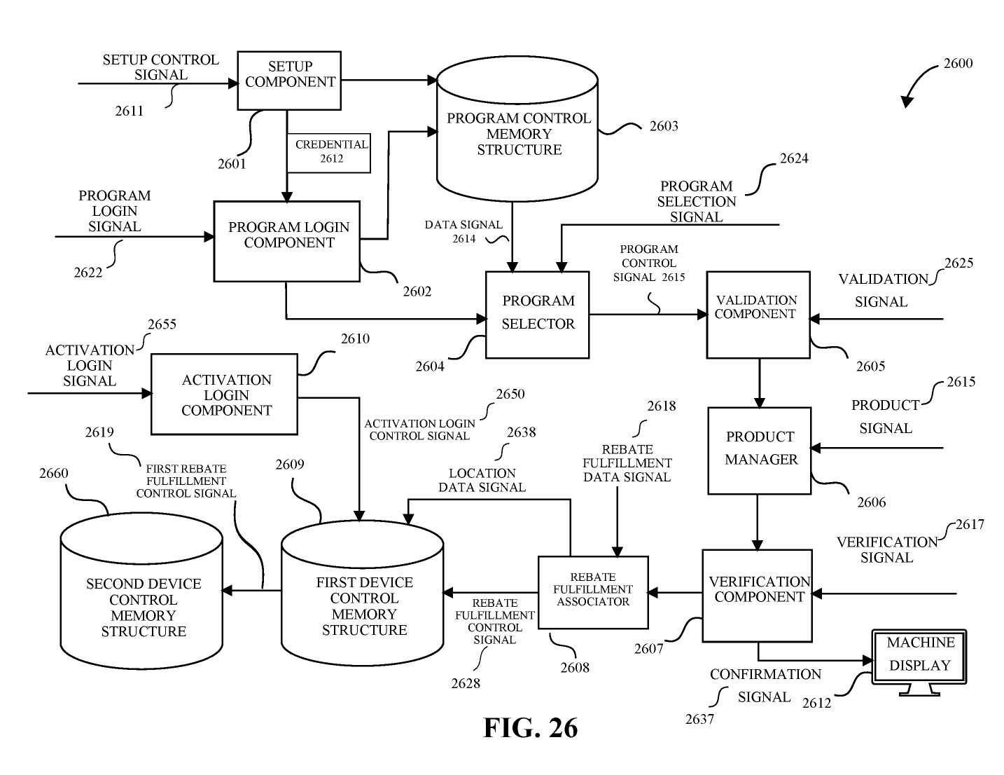

Referring to FIG. 26, an activation system 2600 comprises a setup component 2601, a program login component 2602, a program control memory structure 2603, a program selector 2604, a validation component 2605, a product manager 2606, a verification component 2607, a rebate fulfillment associator 2608, a first rebate fulfillment control memory structure 2609, an activation login component 2610, a second rebate fulfillment control memory structure 2611, and a machine display 2612. The activation system 2600 may comprise the instant rebate management system 2400 (e.g., the enterprise infrastructure and system network of FIGS. 1 and 2) and/or another associated system.

The setup component 2601 receives a setup control signal 2611. The setup component 2601 generates credentials 2612 to be utilized to access the activation system 2600, e.g., credentials to be used by a trade ally to access the instant rebate management system 2400. The credentials 2612 may allow access based on the level of access specified by the setup control signal 2611. The setup component 2601 sends the credentials 2612 to the program login component 2602 to determine when access is granted to a specific program login signal 2622. The setup component 2601 may also create the program control memory structure 2603 and send program information, received via the setup control signal 2611, to the program control memory structure 2603 to be stored. Further setup control signals 2611 may associate another program with a credential 2612 or generate another credential to be associated with one or more programs.

The program login component 2602 may receive a program login signal 2622 and may receive credentials from the setup component 2601. The program login component 2602 may compare the program login signal 2622 to the credentials 2612. If the program login signal 2622 matches a set of credentials 2612, the program login component 2602 sends control signal 2611 to the program control memory structure 2603 to retrieve stored information regarding the credentials matched to the program login signal 2622 and to the program selector 2604 to activate and receive the program information from the program control memory structure 2603.

The program control memory structure 2603 may receive and store information from the setup component 2601. In response to a control signal from the program login component 2602, the program control memory structure 2603 may send the associated data signal 2614 to the program selector 2604.

The program selector 2604 may receive the control signal 2611 from the program login component 2602 and the data signal 2614 from the program control memory structure 2603. The program selector 2604 may also receive a program selection signal 2624 to select a specific program if one or more programs is associated with the credentials 2612 accessed by the program login component 2602. The program selector 2604 then sends a program control signal 2615 to the validation component 2605.

The validation component 2605 may receive a program control signal 2615 from the program selector 2604 and a validation signal 2625. The validation component 2605 may associate information comprised by the validation signal 2625 with the program control signal 2615 received from the program selector 2604. The validation signal 2625 may comprise information such as customer information. The validation component 2605 then sends a validation control signal 2616 to the product manager 2606.

The product manager 2606 may receive a validation control signal 2616 from the validation component 2605 and a product signal 2615. The product signal 2615 may select a portion of the validation control signal 2616 to send to the verification component 2607. In some embodiments, a product is selected from a list of products that comprise a program. The product manager 2606 may also associate information from the product signal 2615 with the selected portion of the validation control signal 2616 received. The information may comprise further product information. The product manager 2606 sends a manager control signal 2626 to the verification component 2607 comprising the selected portion of the validation control signal 2616 received from the validation component 2605 and the associated information from the product signal 2615.

The verification component 2607 receives the manager control signal 2626 from the product manager 2606 and a verification signal. 2617. The verification component 2607 associates information from the verification signal 2617 with the manager control signal 2626 received from the product manager 2606. The information may comprise data files, electronic signatures, etc. The verification component 2607 sends a verification control signal 2627 to the rebate fulfillment associator 2608. The verification component 2607 may also send a confirmation signal 2637 to be displayed on the machine display 2612.

The rebate fulfillment associator 2608 receives the verification control signal 2627 from the verification component 2607 and a rebate fulfillment data signal 2618. The rebate fulfillment associator 2608 associates the rebate fulfillment data signal 2618, which comprises information about an unactivated rebate fulfillment account 2514 and/or rebate fulfillment value 2516, such as a such as a stored value card, with the verificaiton control signal 2627 received from the verification component 2607. The rebate fulfillment associator 2608 sends a rebate fulfillment control signal 2628 to the first rebate fulfillment control memory structure 2609. In some embodiments, the rebate fulfillment associator 2608 sends a location data signal 2638, which may be stored in the first rebate fulfillment control memory structure 2609 or another structure. Furthermore, the location data signal 2638 may be associated with the rebate fulfillment control signal 2628 sent from the rebate fulfillment associator 2608.

The first rebate fulfillment control memory structure 2609 receives a rebate fulfillment control signal 2628 from the rebate fulfillment associator 2608 and an activation login control signal 2650 from the activation login component 2610. In response to the rebate fulfillment control signal 2628 from the rebate fulfillment associator 2608, the first rebate fulfillment control memory structure 2609 may store the rebate fulfillment control signal 2628. In response to the activation login control signal 2650 from the activation login component 2610, the first rebate fulfillment control memory structure 2609 may send the stored information to the second rebate fulfillment control memory structure 2660 and associate the activation login control signal 2650 from the activation login component 2610. In another embodiment, the first rebate fulfillment control memory structure 2609 associates the activation login control signal 2650 from the activation login component 2610 with the corresponding stored rebate fulfillment control signal 2628.

The activation login component 2610 may receive an activation login signal 2655. The activation login component 2610, in response to the activation login signal 2655, sends a activation login control signal 2650 to the first rebate fulfillment control memory structure 2609 to alter the state of information within the first rebate fulfillment control memory structure 2609. In another embodiment, the activation login control signal 2650 comprises instructions to associate the activation login control signal 2650 with specific stored data in the first rebate fulfillment control memory structure 2609 and sends a control signal to the second rebate fulfillment control memory structure 2660 to be stored.

The second rebate fulfillment control memory structure 2660 receives the first rebate fulfillment control signal 2619 from the first rebate fulfillment control memory structure 2609 and stores the first rebate fulfillment control signal 2619.

The setup control signal 2611, the data signal 2614, the program control signal 2615, the validation control signal 2616, the manager control signal 2626, the verification control signal 2627, the confirmation signal 2637, the location data signal 2638, the rebate fulfillment control signal 2628, the activation login signal 2650, the first rebate fulfillment control signal 2619, the program login signal 2622, the activation login signal 2655, the program selection signal 2624, the validation signal 2625, the product signal 2615, the verification signal 2617, and the rebate fulfillment data signal 2618 may be received by a signal processing component. The signal processing component may associated each received signal an associated component for processing. The signal processing component may convert input signals from input devices, such as computing devices, to the signal listed above. The machine display 2612 may be utilized to receive input signals via machine interfaces. The program login signal 2622 and the activation signal 2655 may comprise tokenized authentication.

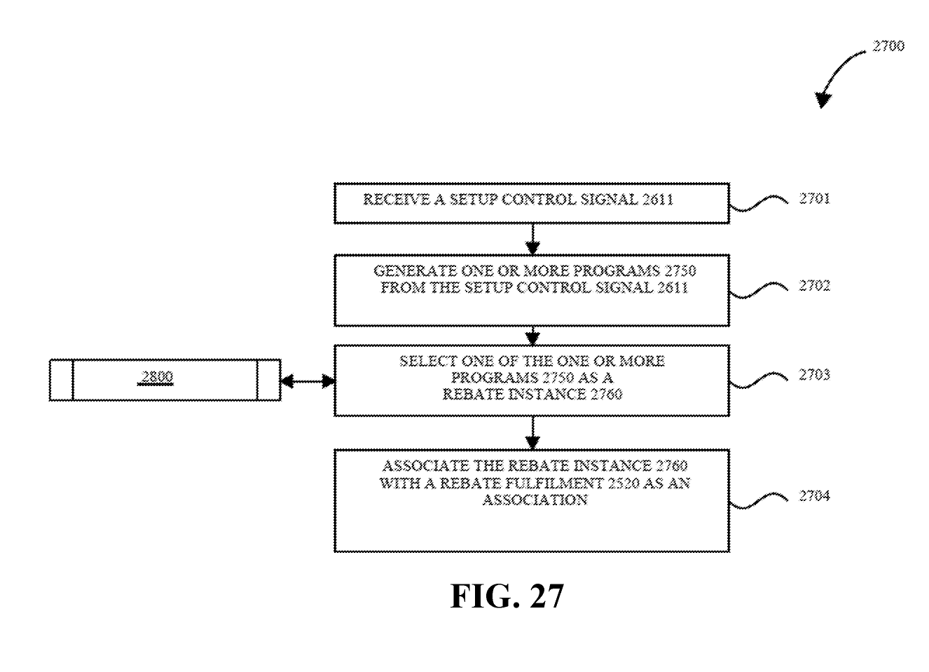

Referring to FIG. 27, a rebate management method 2700 receives a setup control signal 2611 (block 2701). Then, one or more programs 2750 are generated from the setup control signal 2611 (block 2702). The one or more programs 2750 may be associated with credential 2612. The credential 2612 may be utilized to associate a program login signal 2622 with one or more programs 2750. One of the one or more programs 2750 is selected as a rebate instance 2760 ( block 2703). The rebate instance 2760 may be selected by a selection signal 2624 received. The rebate instance 2760 is associated with an unactivated rebate fulfillment account 2514 and/or rebate fulfillment value 2516 as an association (block 2704). The association may be stored with one or more associations.

In one embodiment, an activation login signal 2655 is received. The activation login signal 2655 is associated with one of the associations, the associations being in an inactive state. The association is then altered from the inactive state to an active state.

In another embodiment, a location data signal 2638 is received, and the location data signal 2638 is associated with the rebate instance 2760 and an unactivated rebate fulfillment account 2514 and/or rebate fulfillment value 2516.

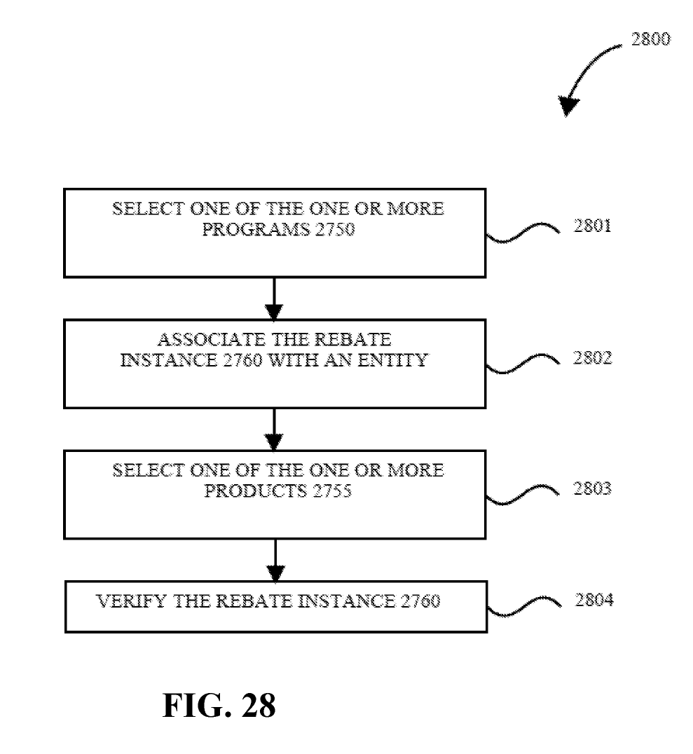

Referring to FIG. 28, a subroutine 2800 selects one of the one or more programs 2750 (block 2801). The one or more programs 2750 may comprise one or more products 2755. The selection may occur in response to a program selection signal 2624. The rebate instance 2760 is associated with an entity 2850 (block 2802). The association may occur in response to a validation signal 2625. One of the one or more products 2755 is selected (block 2803). The product selection may occur in response to a product signal 2615. The rebate instance 2760 is verified (block 2804). The rebate instance 2760 verification may occur in response to a verification signal 2617.

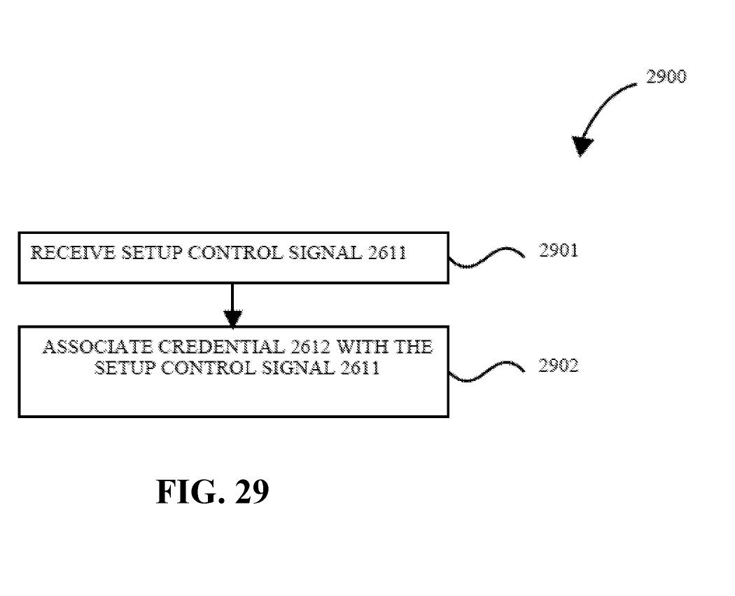

Referring to FIG. 29, the setup method 2900 receives a setup control signal 2611 (block 2901). A credential 2612 is associated with the setup control signal 2611 (block 2902).

The setup control signal 2611 may comprise instructions to generate one or more programs 2750, which may comprise one or more products 2755, in a program control memory structure 2603. The setup control signal 2611 may also be associated with one or more programs previously generated in a program control memory structure 2603.

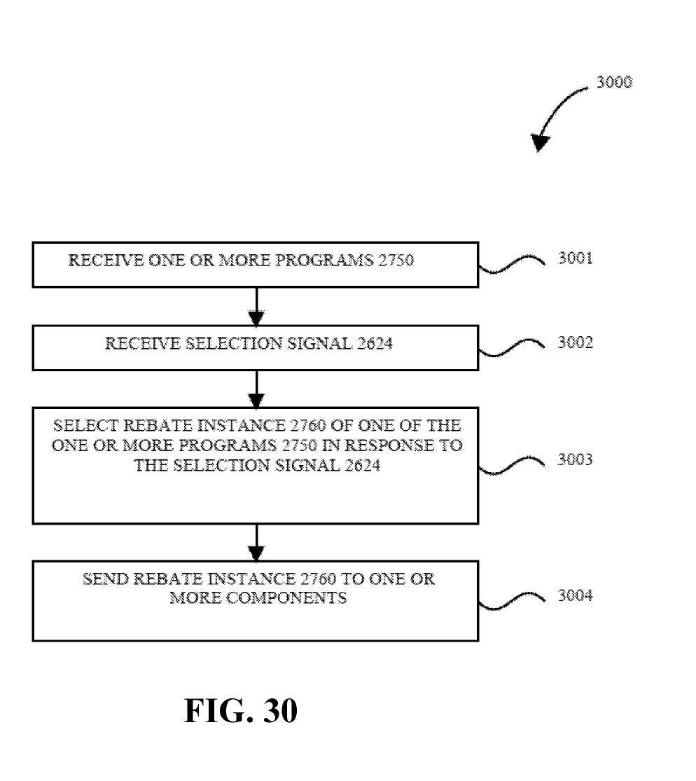

Referring to FIG. 30, the selection method 3000 receives one or more programs 2750 (block 3001). A selection signal 2624 is received (block 3002). In response to the selection signal 2624, a rebate instance 2760 is selected from one of the one or more programs 2750 (block 3003). The rebate instance 2760 is sent to one or more components, e.g., the validation component 2605 (block 3004).

In some embodiments, a program login signal 2622 is utilized to determine the one or more programs 2750 received.

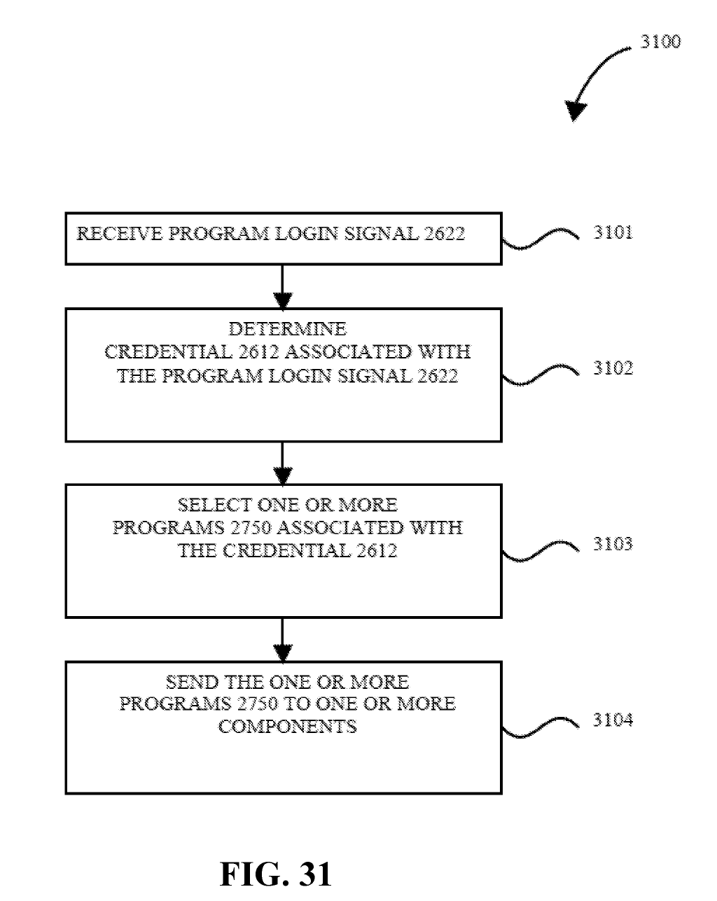

Referring to FIG. 31, the program login method 3100 receives a program login signal 2622 (block 3101). A credential 2612 associated with the program login signal 2622 is determined (block 3102). The one or more programs 2750 associated with the credential 2612 are selected (block 3103). The one or more programs 2750 are sent to one or more components e.g., the validation component 2605 (block 3104).

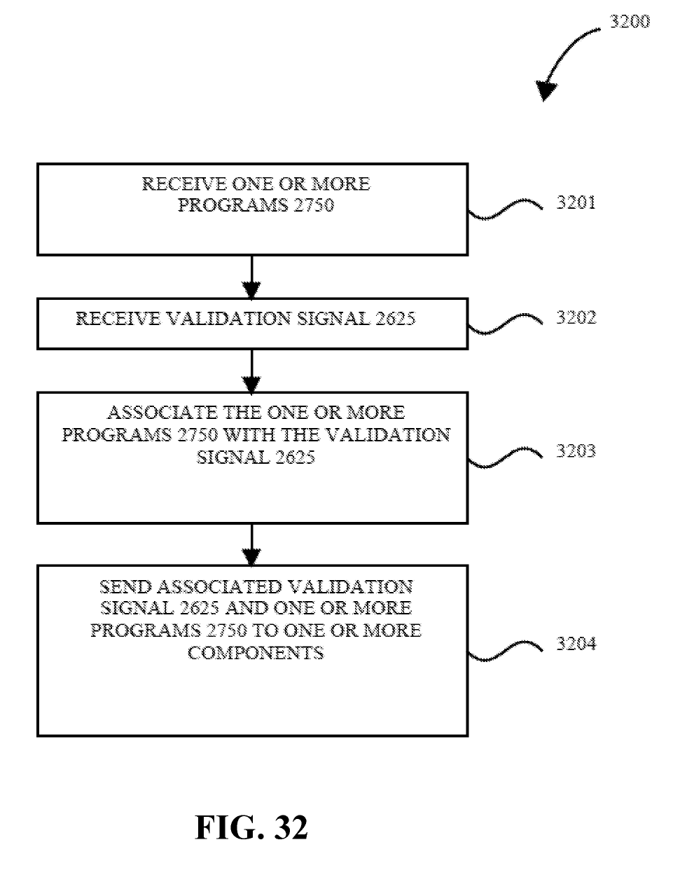

Referring to FIG. 32, the validation method 3200 receives one or more programs 2750 (block 3201). A validation signal 2625 is received (block 3202). The one or more programs 2750 are associated with the validation signal 2625 (block 3203). The associated validation signal 2625 and one or more programs 2750 are sent to one or more components, e.g., the verification component 2607 (block 3204).

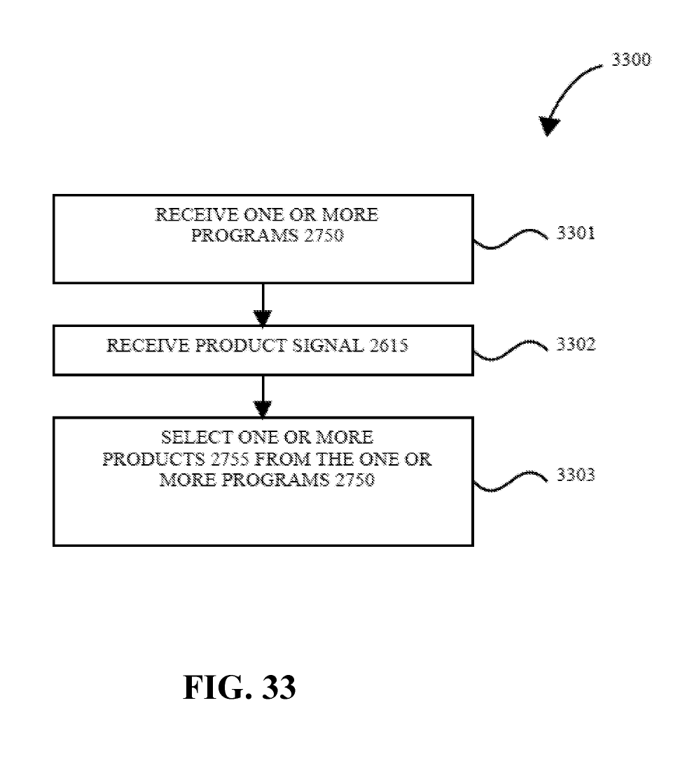

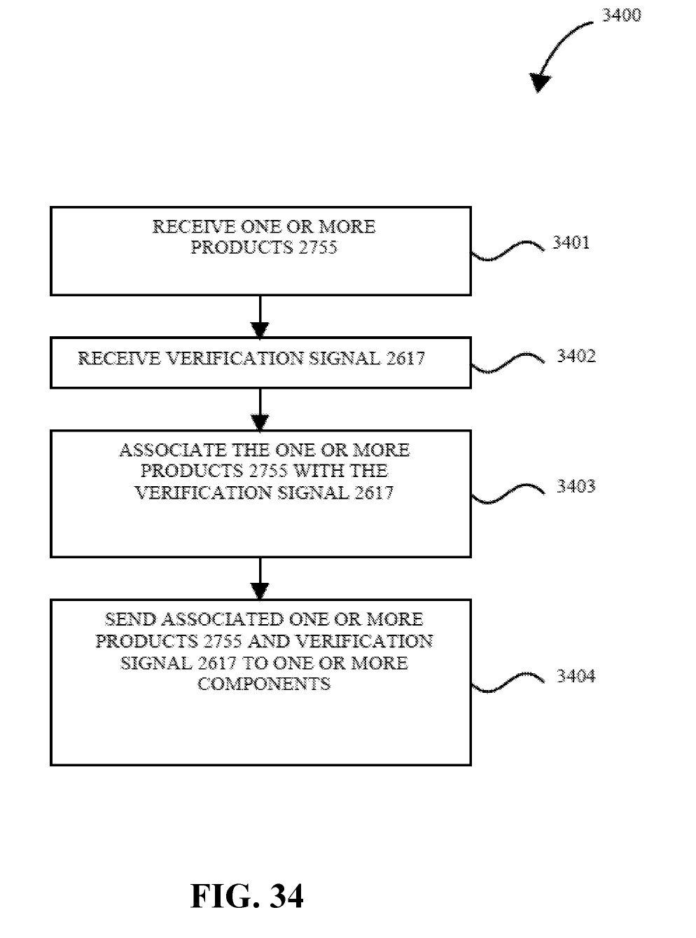

Referring to FIG. 33, the product manager method 3300 receives the one or more programs 2750 (block 3301). A product signal 2615 is received (block 3302). One or more products 2755 is selected from the one or more programs 2750 in response to the product signal 2615 (block 3303).

In some embodiments, the product signal 2615 may further comprise product data 2756. The product data 2756 is associated with the one or more products 2755.

Referring to FIG. 34, the verification method 3400 receives one or more products 2755 (block 3401). A verification signal 2617 is received (block 3402). The one or more products 2755 are associated with the verification signal 2617 (block 3403). The associated one or more products 2755 and verification signal 2617 are sent to one or more components, e.g., the rebate fulfillment associator 2608 (block 3404).

In some embodiments, a confirmation signal 2637 is sent to a machine display 2612, altering the state of the machine display 2612.

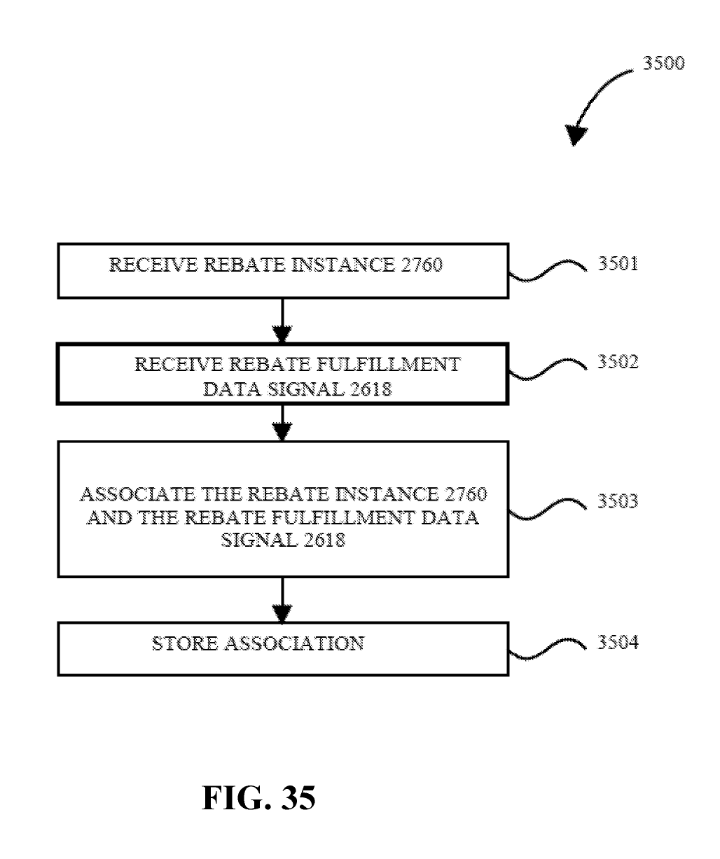

Referring to FIG. 35, the rebate fulfillment association method 3500 receives a rebate instance 2760 (block 3501). A rebate fulfillment data signal 2618 is received (block 3502) . The rebate fulfillment data signal 2618 may be associated with an unactivated rebate fulfillment account 2514 and/or rebate fulfillment value 2516. The rebate fulfillment data signal 2618 is associated with the rebate instance 2760 (block 3503). The association is stored (block 3504).

In some embodiments, a location data signal 2638 is also received. The location data signal 2638 is further associated with the rebate instance 2760 and the rebate fulfillment data signal 2618 (e.g., also associated with an unactivated rebate fulfillment account 2514 and/or rebate fulfillment value 2516).

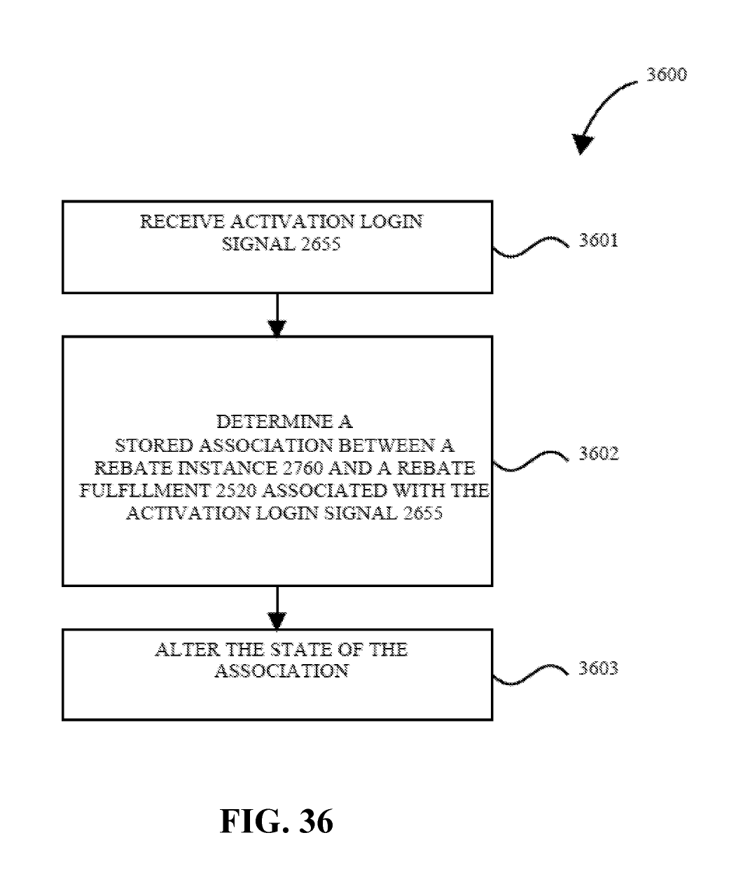

Referring to FIG. 36, the activation login component method 3600 receives an activation login signal 2655 (block 3601). A stored association between a rebate instance 2760 and with an unactivated rebate fulfillment account 2514 and/or rebate fulfillment value 2516 is associated with the activation login signal 2655 (block 3602). The state of the association is altered (block 3603).

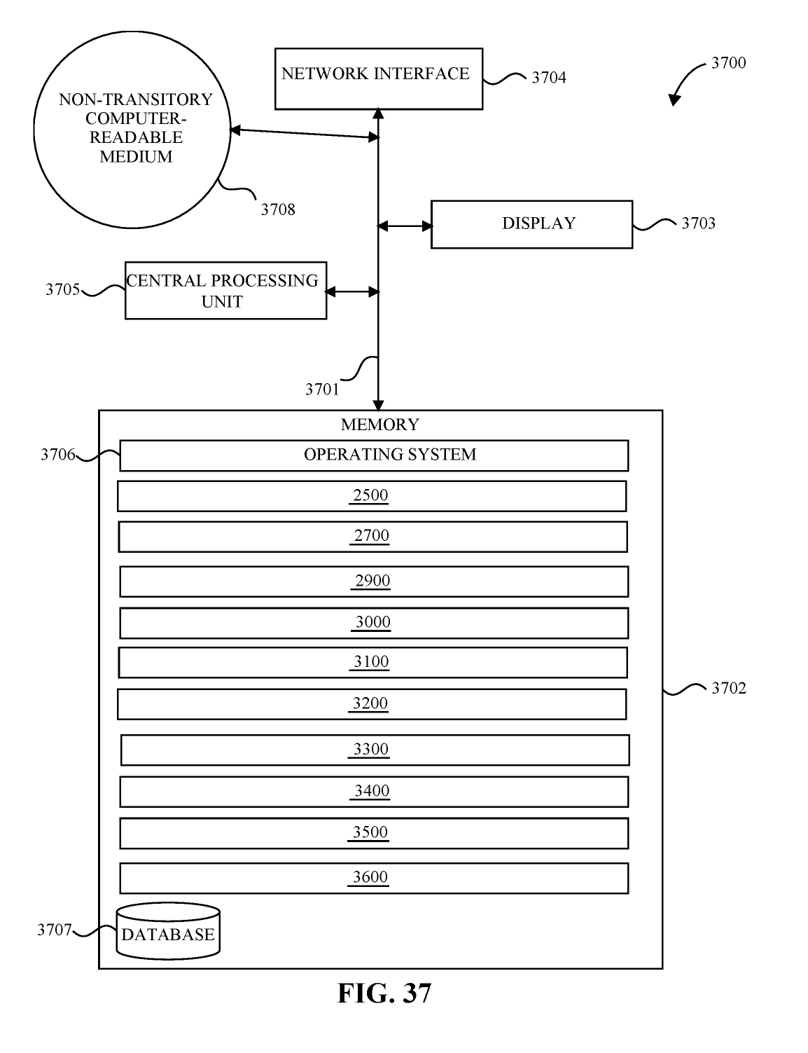

FIG. 37 illustrates several components of an exemplary system 3700 in accordance with one embodiment. In various embodiments, system 3700 may include a desktop PC, server, workstation, mobile phone, laptop, tablet, set-top box, appliance, or other computing device that is capable of performing operations such as those described herein. In some embodiments, system 3700 may include many more components than those shown in FIG. 37. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 3700 may comprise one or more physical and/or logical devices that collectively provide the functionalities described herein. In some embodiments, system 3700 may comprise one or more replicated and/or distributed physical or logical devices.

In some embodiments, system 3700 may comprise one or more computing resources provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

System 3700 includes a bus 3701 interconnecting several components including a network interface 3704, a display 3703, a central processing unit 3705, and a memory 3702.

Memory 3702 generally comprises a random access memory (“RAM”) and permanent non-transitory mass storage device, such as a hard disk drive or solid-state drive. Memory 3702 stores an operating system 3706.

These and other software components may be loaded into memory 3702 of system 3700 using a drive mechanism (not shown) associated with a non-transitory computer-readable medium 3708, such as a floppy disc, tape, DVD/CD-ROM drive, memory card, or the like.

Memory 3702 also includes database 3707. In some embodiments, system 3700 may communicate with database 3707 via network interface 3704, a storage area network (“SAN”), a high-speed serial bus, and/or via the other suitable communication technology.

In some embodiments, database 3707 may comprise one or more storage resources provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

“Associator” in the foregoing description refers to a correlator (see the definition for Correlator).

“Circuitry” in the foregoing description refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Comparator” in the foregoing description refers to a logic element that compares two or more inputs to produce one or more outputs that reflects similarity or difference of the inputs. An example of a hardware comparator is an operational amplifier that outputs a signal indicating whether one input is greater, less than, or about equal to the other. An example software or firmware comparator is: if (input1==input2) output=val1; else if (input1>input2) output=val2; else output=val3; Many other examples of comparators will be evident to those of skill in the art, without undo experimentation.

“Component” in the foregoing description refers to a logic element having distinct machine instructional interfaces for receiving inputs and providing outputs, internal logic to process the inputs into the outputs, and which inter-operates with other components in the system via these interfaces.

“Correlator” in the foregoing description refers to a logic element that identifies a configured association between its inputs. One examples of a correlator is a lookup table (LUT) configured in software or firmware. Correlators may be implemented as relational databases. An example LUT correlator is: |low_alarm_condition |low_threshold_value|0| |safe_condition |safe_lower_bound |safe_upper_bound| |high_alarm_condition|high_threshold_value|0| Generally, a correlator receives two or more inputs and produces an output indicative of a mutual relationship or connection between the inputs. Examples of correlators that do not use LUTs include any of a broad class of statistical correlators that identify dependence between input variables, often the extent to which two input variables have a linear relationship with each other. One commonly used statistical correlator is one that computes Pearson's product-moment coefficient for two input variables (e.g., two digital or analog input signals). Other well-known correlators compute a distance correlation, Spearman's rank correlation, a randomized dependence correlation, and Kendall's rank correlation. Many other examples of correlators will be evident to those of skill in the art, without undo experimentation.

“Firmware” in the foregoing description refers to software logic embodied as processor-executable instructions stored in read-only memories or media.

“Hardware” in the foregoing description refers to logic embodied as analog or digital circuitry.

“Logic” in the foregoing description refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Programmable device” in the foregoing description refers to an integrated circuit designed to be configured and/or reconfigured after manufacturing. The term “programmable processor” is another name for a programmable device herein. Programmable devices may include programmable processors, such as field programmable gate arrays (FPGAs), configurable hardware logic (CHL), and/or any other type programmable devices. Configuration of the programmable device is generally specified using a computer code or data such as a hardware description language (HDL), such as for example Verilog, VHDL, or the like. A programmable device may include an array of programmable logic blocks and a hierarchy of reconfigurable interconnects that allow the programmable logic blocks to be coupled to each other according to the descriptions in the HDL code. Each of the programmable logic blocks may be configured to perform complex combinational functions, or merely simple logic gates, such as AND, and XOR logic blocks. In most FPGAs, logic blocks also include memory elements, which may be simple latches, flip-flops, hereinafter also referred to as “flops,” or more complex blocks of memory. Depending on the length of the interconnections between different logic blocks, signals may arrive at input terminals of the logic blocks at different times.

“Selector” in the foregoing description refers to a logic element that selects one of two or more inputs to its output as determined by one or more selection controls. Examples of hardware selectors are multiplexers and demultiplexers. An example software or firmware selector is: if (selection_control==true) output=input1; else output=input2; Many other examples of selectors will be evident to those of skill in the art, without undo experimentation.

“Software” in the foregoing description refers to logic implemented as processor-executable instructions in a machine memory (e.g. read/write volatile or nonvolatile memory or media).

“Stored value card” in the foregoing description may refer to a transaction device that may be used to transact business with a party willing to accept the card, for example as tender for a purchase. Examples of such cards include gift cards, prepaid telephone cards, loyalty cards, membership cards, ticket cards, entertainment cards, sports cards, prepaid cards, and the like. Typically, such cards are wallet-sized and made of plastic. In various embodiments, the transaction card may be a type of card such as a gift or prepaid card that requires activation at a point of sale. For example, a stored value card may be purchased and activated at a point of sale by a consumer and subsequently used by the consumer or another (e.g., the recipient of the card as a gift) to transact business.

“Switch” in the foregoing description refers to logic to select one or more inputs to one or more outputs under control of one or more selection signals. Examples of hardware switches are mechanical electrical switches for switching power to circuits, devices (e.g., lighting), or motors. Other examples of hardware switches are solid-state switches such as transistors. An example of a hardware or firmware switch is: if (selection==true) output=input; else output=0; A somewhat more complicated software/firmware switch is: if (selection1==true and selection2 ==true) output=input1); else if (selection1==true and selection2==false) output=input2; else if (selection1==false and selection2==true) output=input3; else output=noOp; Switches operate similarly to selectors in many ways (see the definition of Selector), except in some cases switches may select all inputs to the output,(s) not select among inputs. Other examples of switches will be readily apparent to those having skill in the art, without undo experimentation.

The foregoing description of an implementation has been presented for purposes of illustration and description. It is not exhaustive and does not limit the claimed embodiments to the precise form disclosed. Modifications and variations are possible in light of the above description or may be acquired from practicing the disclosure. For example, persons skilled in the art will understand and appreciate, that one or more processes, sub-processes, or process steps described in connection with FIGS. 1 through 37 may be performed by hardware and/or software. Additionally, a target management and consumer management system, as described above, may be implemented completely in software that would be executed within a processor or plurality of processors in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory (not shown) in the device used to execute the software. The software in software memory may include an ordered listing of executable instructions for implementing logical functions, i.e., “logic” that may be implemented either in digital form such as digital circuitry or source code or optical circuitry or chemical or biochemical in analog form such as analog circuitry or an analog source such an analog electrical, sound or video signal, and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions and transform the computer, processor, device, and/or apparatus into a particular machine to perform the particular methods required by the executable instructions. In the context of this document, a “machine-readable medium,” “computer-readable medium,” and/or “signal-bearing medium” (hereinafter, “Signal-Bearing Medium”) is any means that may contain, store, communicate, propagate, or transport the program for use by or in connection with the instruction execution system, apparatus, or device. The Signal-Bearing Medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a Signal-Bearing Medium may include carrier wave signals on propagated signals in telecommunication and/or network distributed systems. These propagated signals may be computer, i.e., machine data signals embodied in the carrier wave signal. The computer/machine data signals may include data or software that is transported or interacts with the carrier wave signal.

It is understood that by programming and/or loading executable instructions onto a computer system disclosed herein, e.g., the system and network disclosed in FIGS. 1-37, at least one of the disclosed systems processors, RAM, and ROM are changed, transforming the computer system in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Note also that the implementation may vary between systems. The claims and their equivalents define the scope of the invention.

What is claimed is:

1. A system comprising:
a setup component, the setup component configured to:
receive a setup control signal, the setup control signal comprising one or more programs; and
associate a credential with the setup control signal;
a program control memory structure, the program control memory structure configure to store the one or more programs and the credential associated with the one or more programs;
a selection component, the selection component configure to:
receive a selection signal; and
select a rebate instance of one of the one or more programs in response to the selection signal;
a rebate fulfillment associator, the rebate fulfillment associator configured to associate a physical rebate fulfillment with the rebate instance as an association; and
a first rebate fulfillment control memory structure, the first rebate fulfillment control memory structure storing the association of the rebate fulfillment and the rebate instance.

2. The system of claim 1, further comprising a program login component, the program login component configured to:
receive a program login signal;
determine the credential associated with the program login signal; and
select the one or more programs associated with the credential.

3. The system of claim 1, wherein the selection component comprises:
a program selector;
a validation component;
a product manager; and
a verification component.

4. The system of claim 1, further comprising:
an activation login component, the activation login component configure to receive an activation login signal; and
a second rebate fulfillment control memory structure, wherein the first rebate fulfillment control memory structure sends the association associated with the activation login signal to the second rebate fulfillment control memory structure.

5. The system of claim 1, further comprising a machine display, the machine display configure to display a confirmation signal generated by the selection component.

6. The system of claim 1, wherein the rebate fulfillment associator further associates a location data signal with the association.

7. The system of claim 1, wherein the rebate fulfillment is a stored value card.

8. A method comprising:
receiving a setup control signal;
generating one or more programs from the setup control signal;
selecting one of the one or more programs as a rebate instance; and
associating the rebate instance with a rebate fulfillment as an association.

9. The method of claim 8, further comprising:
associating the one or more programs with a credential;
receiving a program login signal;
determining the credential associated with the program login signal; and
selecting the one or more programs associated with the credential.

10. The method of claim 8, wherein selecting one of the one or more programs as the rebate instance comprises:
selecting one of the one or more programs, the one or more programs comprising one or more products;
associating the rebate instance with an entity;
selecting one of the one or more products; and
verifying the rebate instance.

11. The method of claim 8, further comprising:
receiving an activation login signal;
associating the activation login signal with one of the association, the association being in an inactive state; and
altering the association from the inactive state to an active state.

12. The method of claim 8, further comprising:
receiving a location data signal; and
associating the location data signal with the rebate instance and the rebate fulfillment.
